(19) United States
(12) Patent Application Publication
(10) Pub. No.: US 2017/0269798 A1
(43) Pub. Date: Sep. 21, 2017

(54) Computerized Content Recommendation Based on Container Interactions

(71) Applicant: Microsoft Technology Licensing, LLC, Redmond, WA (US)

(72) Inventors: Dmitriy Meyerzon, Bellevue, WA (US); David M. Cohen, Duvall, WA (US); Bjornstein Lilleby, Tromso (NO); Aninda Ray, Sammamish, WA (US); Yauhen Shnitko, Sammamish, WA (US); Vidya Srinivasan, Issaquah, WA (US); Michael Taylor, Cambridge (GB); Vidar Vikjord, Tromso (NO); Nikita Voronkov, Bothell, WA (US)

(21) Appl. No.: 15/076,170

(22) Filed: Mar. 21, 2016

(51) Int. Cl. G06F 3/0482; G06F 17/30; G06T 11/20

(52) U.S. Cl. CPC G06F 3/0482; G06T 11/206; G06F 17/30424; G06F 17/30292; G06F 17/3053

(57) ABSTRACT

Relevant content can be surfaced via user interfaces presented via devices based at least partly on determining the relevant content from interactions between user(s), container(s), and/or container element(s). Techniques described herein include accessing data associated with interactions between a user and content (e.g., containers and container elements) associated with a collaborative computing environment. Based at least partly on the data, relationships between the user, container(s), and/or container element(s), and weights corresponding to individual relationships of the relationships can be determined. Techniques described herein include determining at least a portion of the content that is relevant to the user based at least partly on the weights and generating a content page associated with the collaborative computing environment configured with functionality to surface at least the portion of the content. The portion of the content can be prioritized on the user interface based at least partly on the weights.

### BACKGROUND

Data storage and processing have become major components of networked systems for handling interactions between multiple devices on behalf of corresponding users. A collaborative computing environment enables users to store files in a single network location that is accessible to other users who are a part of the collaborative computing environment. Additionally or alternatively, a collaborative computing environment enables users to sync files between the multiple devices, share files between the multiple devices, etc., and collectively work on the files that have been synced and/or shared between the multiple devices. Collaboration services that are accessible via a collaborative computing environment enable multiple users to author, edit, view, etc. various files at substantially the same time. Edits made by a user to a file can be shown to other users in the collaborative computing environment in substantially real time via the networked system. In some examples, service providers offering collaboration services (e.g., MICROSOFT® SHAREPOINT®, GOOGLE® Drive, DROPBOX®, etc.) offer a home page for a user to preview files that he or she has shared and/or synced with other users.

Current techniques organize the files on the home page by title and/or timestamp indicating when a file was uploaded, shared, modified, etc. Generally, there is little or no visual distinction between documents, and keeping track of particular files that have been shared and/or synced can be difficult. Furthermore, different files can vary in importance to a user depending on timing. For instance, a user may be working on a rush work project that is important to the user in the time leading up to the deadline associated with the rush work project. Or, a user may have worked on a project, and after several months, the project can have little or no importance to the user. Current techniques do not take importance—or relevance—into account when organizing files in content pages associated with a collaborative computing environment. That is, the lack of visual distinction and/or organization makes it difficult for users to search for files that are part of a collaborative computing environment.

### SUMMARY

Relevant content can be surfaced via user interfaces that are presented to a user based at least partly on determining the relevant content from interactions between user(s), container(s), and/or container element(s). Techniques described herein include accessing data associated with interactions between a user and content (e.g., containers and container elements) associated with a collaborative computing environment. Based at least partly on the data, relationships between the user, container(s), and/or container element(s) can be determined. Additionally, weights corresponding to the relationships can be determined. Techniques described herein include determining at least a portion of the content that is relevant to the user, based at least partly on the weights, and generating a content page associated with the collaborative computing environment configured with functionality to surface at least the portion of the content. The portion of the content can be prioritized on the user interface based at least partly on the weights.

In additional and/or alternative examples, techniques described herein can include generating a data structure (e.g., a graph, etc.) to represent relationships between the user, container(s), and/or container element(s). In at least one example, the weights can be leveraged for determining edges between pairs of objects in the data structure. By leveraging the data structures to organize relationships between user(s), container(s), and/or container element(s), the techniques described herein can increase efficiency in locating relevant content that can be surfaced for the users via user interfaces described herein. Furthermore, by leveraging the data structures to organize relationships between user(s), container(s), and/or container element(s), the techniques described herein can reduce computational resources that are expended in locating content that can be surfaced for the users in collaborative computing environments, as described herein.

The techniques described herein are directed to presenting user interfaces to users that can be configured to surface content that is relevant to the users. In some examples, a user interface can be associated with a content page corresponding to a collaborative service environment. Based at least in part on identifying containers and container elements associated with individual containers that are relevant to a user, the techniques described herein can present the user with a customized content page that displays content (e.g., containers, container items, etc.) that the user is likely to be interested in accessing at a particular moment in time. The techniques described herein enable users to access content more efficiently, with fewer interactions than are required for current techniques. Based at least in part on surfacing the relevant content via customized content pages, the techniques described herein can enable users to quickly access previously started work, leading to faster task completion.

This Summary is provided to introduce a selection of concepts in a simplified form that are further described below in the Detailed Description. This Summary is not intended to identify key or essential features of the claimed subject matter, nor is it intended to be used to limit the scope of the claimed subject matter.

### BRIEF DESCRIPTION OF THE DRAWINGS

The Detailed Description is set forth with reference to the accompanying figures, in which the left-most digit of a reference number identifies the figure in which the reference number first appears. The use of the same reference numbers in the same or different figures indicates similar or identical items or features.

FIG. 1 is a schematic diagram showing an example environment for determining content that is relevant to user(s) based at least in part on interactions between the user(s), container(s), and/or container element(s) and surfacing relevant content via user interfaces presented via devices(s) associated with the user(s).

FIG. 2 is a schematic diagram that illustrates an example of a data structure generated to define relationships between user(s), container(s), and/or container element(s).

FIG. 3 is a flow diagram that illustrates an example process to generate a user interface that is personalized for a user based at least in part on a data structure that represents relationships between user(s), container(s), and/or container element(s).

FIG. 4 is a flow diagram that illustrates an example process to generate a result responsive to a query associated with container(s) and/or container element(s) in a collaborative computing environment.

### DETAILED DESCRIPTION

This disclosure describes determining content that is relevant to a user based at least in part on previous interactions between user(s), container(s), and/or container element(s), and surfacing relevant content in user interfaces presented via a device corresponding to the user. In at least one example, the container(s), and associated container element(s), can be associated with a collaborative computing environment and the user interface can correspond to a content page configured to identify and/or recommend content that is relevant to individual users based on content items that a user is working on, other users that the user is working with, what those users are working on, and, in some examples, user permissions.

For the purpose of this discussion, content can describe containers and container elements associated with the containers. In at least one example, a container is a data structure that is associated with one or more container elements. Non-limiting examples of containers include team sites, publishing sites, group sites, blogging sites, video channels, image channels, data streaming channels, folders, applications, etc. Container elements are associated with containers. Examples of container elements can include documents, wikis, blog posts, web pages, videos, images, information items, data streams, etc. As a non-limiting example, a team site container can include a plurality of container elements including documents (e.g., an article the team is collaborating on, an expense report for the team, a list of items associated with workflow, etc.), images, videos, etc. Or, a blogging site container can include a plurality of container elements that each correspond to different blog posts published (or to be published) on the blog site. A video channel container can include a plurality of container elements that each correspond to different videos that are available via the video channel.

The techniques described herein can generate data structures, such as graphs, for identifying relationships between user(s), container(s), and/or container element(s). In at least one example, the relationships can be determined based at least in part on interactions between user(s), container(s), and/or container element(s). In some examples, the relationships can be based on explicit actions. For instance, a relationship can be determined between a user and a container element based on the user generating the container element. In other examples, the relationships can be inferred. For instance, a relationship between a user and a container element can be inferred based at least in part on a user that is associated with the user editing or modifying a container element associated with a container that the user created (e.g., a friend of the user editing or modifying a container element or a colleague of the user editing or modifying the container element). Or, a relationship between a user and a container element can be inferred based at least in part on other users that are associated with the user viewing, sharing, tagging, etc. a container element (e.g., friends of the user viewing, sharing, tagging, etc. a container element and/or colleagues of the user viewing, sharing, tagging, etc. the container element).

The techniques described herein can access the data structures and can leverage the relationships represented in the data structures for identifying content (e.g., containers and container elements associated with the containers) that is relevant to users. For instance, the techniques described herein include determining which containers are relevant to a user based at least in part on the data structures and identified relationships. Based at least in part on determining that a container is relevant to the user, the techniques described herein include determining which container elements that are associated with the container are relevant to the user. In at least one example, techniques described herein can leverage user interfaces to surface content (e.g., container(s) and associated container element(s)) that is likely to be relevant to users at a particular time, and to hide content that is not likely to be relevant to users at the particular time. For the purpose of this discussion, relevance can refer to the importance of a content item to a user based at least in part on what a user is working on, who a user is working with, what those users are working on, and, in some examples, user permissions. Furthermore, relevance can refer to a likelihood of a user clicking, touching, or otherwise selecting a container and/or container element to continue his or her work, discover an update, etc.

By leveraging the data structures to organize relationships between user(s), container(s), and/or container element(s), the techniques described herein can increase efficiency in locating relevant content that can be surfaced for the users via user interfaces described herein. Furthermore, by leveraging the data structures to organize relationships between user(s), container(s), and/or container element(s), the techniques described herein can reduce computational resources that are expended in locating content that can be surfaced for the users in collaborative computing environments, as described herein.

As described above, the user interfaces presented to users via devices associated with the users can be configured to surface content that is relevant to the users. In some examples, a user interface can be associated with a content page corresponding to a collaborative service application (i.e., an application facilitating a collaborative computing environment). Based at least in part on identifying containers and container elements associated with individual containers that are relevant to a user, the techniques described herein can present a customized content page to the user that displays content (e.g., containers, container items, etc.) that the user is likely to be interested in accessing at a particular moment in time. The techniques described herein enable users to access content more efficiently, with fewer interactions than are required for current techniques. Based at least in part on surfacing the relevant content via customized content pages, the techniques described herein can enable users to quickly access previously started work, leading to faster task completion.

In at least one example, the customized content page can include interface elements corresponding to individual containers and container elements. In some examples, interface elements associated with containers can be graphical elements, such as cards. A card can be a convenient means of displaying content that serves as an entry point to more detailed information. Cards associated with various containers can be organized on the content page according to relevance as determined herein to quickly disseminate relevant information to the users. In at least one example, individual cards can be associated with a group of one or more interface elements corresponding to container elements that are associated with respective containers. The interface elements corresponding to the container elements can be organized on the card according to relevance as determined herein.

In a non-limiting example, a group of employees can be associated with a same team. A first team member can generate a team site (i.e., a container) for the team and can share the team site with the other team members via a collaborative computing environment. Other team members can add documents, videos, images, information items, etc. (i.e., container elements) to the team site. All of the team members can view, edit, share, tag, etc. each of the documents, videos, images, information items, etc. associated with the team site, according to permissions. The techniques described herein can be leveraged to identify content items (e.g., documents, videos, images, information items, etc.) that are relevant to each of the team members based at least in part on interactions between the team members, the team site, and the documents, videos, images, information items, etc. associated with the team site. For instance, a content page associated with the collaborative computing environment can include a graphical element representative of the team site. In some examples, as described above, the graphical element can be a card. One or more graphical elements representative of various container elements (e.g., documents, videos, images, information items, etc.) can be associated with the card. The one or more graphical elements can correspond to links to container elements with relevant recent activity or a list of tasks for the team to complete. The graphical elements corresponding to the container elements can be organized on the card according to relevance as determined herein. Based at least in part on surfacing the relevant content via a customized content page, the techniques described herein can enable the team members to quickly access previously started work and/or observe what other team members are doing, leading to collaborative task completion.

### Illustrative Environments

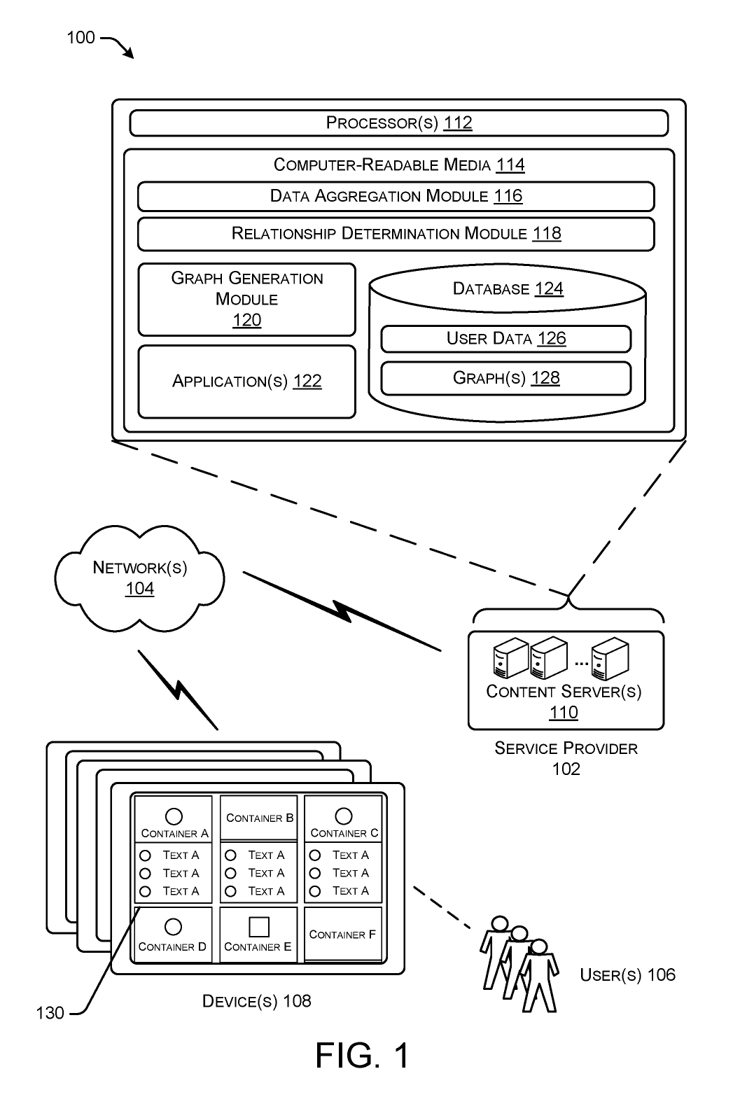

FIG. 1 is a schematic diagram showing an example environment 100 for determining content that is relevant to user(s) based at least in part on interactions between the user(s), container(s), and/or container element(s), and surfacing relevant content via user interfaces presented via device(s) associated with the user(s). More particularly, the example environment 100 can include a service provider 102, network(s) 104, user(s) 106, and device(s) 108 associated with individual ones of the user(s) 106.

The service provider 102 can be any entity, server(s), platform, etc., that facilitates determining content that is relevant to user(s) 106 based at least in part on interactions between the user(s) 106, container(s), and/or container element(s), and surfacing the relevant content via user interfaces as described herein. In at least one example, the service provider 102 can be associated with providing collaboration services. As described above, collaboration services available via a collaborative computing environment enable multiple users 106 to author, edit, view, etc., various files at substantially the same time so that other users 106 can access newly added files and/or recently updated files in substantially real time. The service provider 102 can be implemented in a non-distributed computing environment or can be implemented in a distributed computing environment, possibly by running some modules on remotely located devices (e.g., device(s) 108). As shown, the service provider 102 can include one or more servers 110, which can include one or more processing units 112 and computer-readable media 114, such as memory.

In various examples, the service provider 102 can access data associated with interactions between user(s) 106, container(s), and/or container element(s). In at least one example, the service provider 102 can aggregate the data to determine relationships between user(s) 106, container(s), and/or container element(s). The service provider 102 can leverage the relationships to generate data structures that represent relationships between user(s) 106, container(s), and/or container element(s). The service provider 102 can leverage the data structures to identify content (e.g., container(s) and/or container element(s)) that is relevant to user(s) 106 to surface via device(s) 108 corresponding to the user(s) 106, and can generate user interfaces customized for particular user(s) 106 based at least in part on the content that is determined to be relevant to the particular user(s) 106. Additionally and/or alternatively, in some examples, the service provider 102 can utilize the data structures to generate results responsive to queries associated with the container(s) and/or container element(s) to accommodate a search associated with the collaborative services offered by service provider 102.

In some examples, the network(s) 104 can be any type of network known in the art, such as the Internet. Moreover, the server(s) 110 and/or the device(s) 108 can communicatively couple to the network(s) 104 in any manner, such as by a global or local wired or wireless connection (e.g., local area network (LAN), intranet, etc.). The network(s) 104 can facilitate communication between the server(s) 110 and the device(s) 108 associated with the user(s) 106.

Examples support scenarios where device(s) that can be included in the one or more servers 110 can include one or more computing devices that operate in a cluster or other configuration to share resources, balance load, increase performance, provide fail-over support or redundancy, or for other purposes. Device(s) included in the one or more servers 110 can represent, but are not limited to, desktop computers, server computers, web-server computers, personal computers, mobile computers, laptop computers, tablet computers, wearable computers, implanted computing devices, telecommunication devices, automotive computers, network enabled televisions, thin clients, terminals, game consoles, gaming devices, work stations, media players, digital video recorders (DVRs), set-top boxes, cameras, integrated components for inclusion in a computing device, appliances, or any other sort of computing device. That is, device(s) that can be included in the one or more servers 110 can include any type of computing device having one or more processing units (e.g., processor(s) 112) operably connected to computer-readable media 114 such as via a bus, which in some instances can include one or more of a system bus, a data bus, an address bus, a PCI bus, a Mini-PCI bus, and any variety of local, peripheral, and/or independent buses. In at least one configuration, the computer-readable media 114 of the server(s) 110 can include module(s) that facilitate determining relevant content for user(s) 106. The module(s) can include a data aggregation module 116, a relationship determination module 118, and a graph generation module 120. Additionally, the computer-readable media 114 can include application(s) 122 and a database 124. The database 124 can store user data 126 and data structures, such as graph(s) 128.

Alternatively, or in addition, the functionality described herein can be performed, at least in part, by one or more hardware logic components such as accelerators. For example, and without limitation, illustrative types of hardware logic components that can be used include Field-Programmable Gate Arrays (FPGAs), Application-Specific Integrated Circuits (ASICs), Application-Specific Standard Products (ASSPs), System-on-a-Chip Systems (SOCs), Complex Programmable Logic Devices (CPLDs), etc. Device(s) that can be included in the one or more server(s) 110 can further include one or more input/output (I/O) interface(s) coupled to the bus to allow device(s) to communicate with other devices such as input peripheral devices (e.g., a keyboard, a mouse, a pen, a game controller, a voice input device, a touch input device, gestural input device, and the like) and/or output peripheral devices (e.g., a display, a printer, audio speakers, a haptic output, and the like). Such network interface(s) can include one or more network interface controllers (NICs) or other types of transceiver devices to send and receive communications over a network. For simplicity, some components are omitted from the illustrated environment.

Processing unit(s) (e.g., processor(s) 112) can represent, for example, a CPU-type processing unit, a GPU-type processing unit, a Field-Programmable Gate Array (FPGA), another class of Digital Signal Processor (DSP), or other hardware logic components that can, in some instances, be driven by a CPU. For example, and without limitation, illustrative types of hardware logic components that can be used include Application-Specific Integrated Circuits (ASICs), Application-Specific Standard Products (ASSPs), System-on-a-Chip systems (SOCs), Complex Programmable Logic Devices (CPLDs), etc. In various examples, the processing unit(s) (e.g., processor(s) 112) can execute one or more modules and/or processes to cause the server(s) 110 to perform a variety of functions, as set forth above and explained in further detail in the following disclosure. Additionally, each of the processing unit(s) (e.g., processor(s) 112) can possess its own local memory, which also can store program modules, program data, and/or one or more operating systems.

As described above, in at least one configuration, the computer-readable media 114 of the server(s) 110 can include module(s) that facilitate determining relevant content for user(s) 106 and generating user interface(s) to surface the relevant content to the user(s) 106. The module(s) can represent pieces of code executing on a computing device. In some examples, a module can include an Application Program Interface (API) to perform some or all of its functionality (e.g., operations). In additional and/or alternative examples, the module(s) can be implemented as computer-readable instructions, various data structures, and so forth via at least one processing unit (e.g., processor(s) 112) to configure a device to execute instructions and to perform operations for determining content that is relevant to user(s) 106 and surfacing the relevant content via user interfaces presented to the user(s) 106. Functionality to perform these operations can be included in multiple devices or a single device.

The data aggregation module 116 can aggregate data associated with interactions between user(s) 106, container(s), and/or container element(s). The data aggregation module 116 can receive, access, or determine data from local storage associated with the device(s) 108 and/or service provider 102 (e.g., user data 126), remote storage repositories associated with the device(s) 108 and/or the service provider 102, and/or third party sources or systems. The data can indicate interactions between user(s) 106, container(s), and/or container element(s). For instance, the data can indicate a container with which a user 106 interacts, how the user 106 interacts with the container, and a time associated with the interaction (e.g., timestamp). In at least one example, the data can indicate that a container has been generated by a user 106, a container and/or a home page associated with the container has been viewed by a user 106, a container has been shared by a user 106, a container has been followed by a user 106, a container has been tagged by a user 106, a container has been modified by a user 106, etc. In at least one example, an interaction between a user 106 and a container element associated with a container can generate data indicating that the user 106 interacted with the container. As described above, the data can identify a container which has received an interaction, an action associated with the interaction (e.g., view, edit, share, comment, etc.), the actor (e.g., which user 106 performed the action), a timestamp associated with the interaction, etc. For the purpose of this discussion, the timestamp can reflect actual time (e.g., hour, minute, second, etc.) or relative time (e.g., one second ago, one minute ago, one week ago, etc.).

As a non-limiting example, the data can indicate that a user 106 interacted with a team site container that is associated with a plurality of container elements. The team site container can be associated with a plurality of users 106 who are part of a team are working on the plurality of container elements collaboratively. Or, the data can indicate that a user 106 interacted with a blogging site that is associated with a plurality of container elements that each correspond to different blog posts.

In some examples, the data can indicate user actions corresponding to container elements that are associated with individual containers. In at least one example, the data can identify a container element that was generated by a user 106, has been uploaded by the user 106, has been shared by a user 106, has been followed by a user 106, etc. In some examples, the data can indicate a container element that has been viewed by a user 106, edited by a user 106, reviewed by a user 106, commented on by a user 106, tagged by a user 106, etc. In additional and/or alternative examples, the data can indicate that a container element has been send as a link or attachment in a message, presented in a meeting, etc. The data can identify a container element which has received an interaction, an action associated with the interaction (e.g., view, edit, share, comment, etc.), the actor (e.g., which user 106 performed the action), a timestamp associated with the interaction, etc. For the purpose of this discussion, the timestamp can reflect actual time (e.g., hour, minute, second, etc.) or relative time (e.g., one second ago, one minute ago, one week ago, etc.), as described above.

As a non-limiting example, the data can indicate that a user 106 uploaded a document into a team site container and the user 106 modified a document associated with the team site container. Or, the data can indicate that a user 106 uploaded a document into a team site container and another user 106 who is a member of the team edited a document associated with the team site container generated by the user 106.

Furthermore, the data can identify other users 106 with whom the user 106 is associated and/or interacts. In at least one example, the data can be associated with emails sent or received from user(s) 106, calendar invitations associated with user(s) 106, social networking contacts associated with user(s) 106, etc. The data associated with the emails can indicate other users 106 that send or receive emails associated with a user 106. Or, data associated with calendar invitations can indicate other users 106 who were invited to and/or participated in a meeting associated with a user 106. Moreover, social networks can provide lists of users 106 who are in contact with a user 106, and in some examples strengths associated with relationships between users 106. Additional and/or alternative data can be used for identifying relationships between users 106. In at least one example, the data can identify other users 106 who are organizationally related to a user 106 (e.g., coworkers, team members, etc.). In additional and/or alternative examples, the data can identify other users 106 who are socially related to the user 106 (e.g., family, friends, etc.).

In at least one example, the data can indicate permissions data associated with user(s) 106, container(s), and/or container element(s). The permissions data can identify user(s) 106 that are permitted to access particular containers and/or container elements, etc.

The data can be stored in the user data 126 of the database 124 in a user profile associated with each user 106. In at least one example, the data aggregation module 116 can access the data that is stored in the user data 126 at a particular frequency, after a lapse in a period of time, after an occurrence of a particular event (e.g., accessing, receiving, determining new data, etc.), etc.

In some examples, the data aggregation module 116 can access, receive, and/or determine data associated with public sources. However, in other examples, the data aggregation module 116 can access, receive, and/or determine data associated with private sources that are not accessible to the public. In such examples (i.e., when the data sources are private sources and/or the data is associated with personally identifiable information (PII)), the systems and methods described herein may not proceed without first obtaining permission from the user(s) 106 associated with the data. In such examples, a user 106 can be provided with notice that the systems and methods herein are collecting PII. Additionally, prior to initiating PII data collection, users can have an opportunity to opt-in or opt-out of the PII data collection. For example, a user can opt-in to the PII data collection by taking affirmative action indicating that he or she consents to the PII data collection. Alternatively, a user can be presented with an option to opt-out of the PII data collection. An opt-out option can require an affirmative action to opt-out of the PII data collection, and in the absence of affirmative user action to opt-out, PII data collection can be impliedly permitted.

The relationship determination module 118 can determine relationships between user(s) 106, container(s), and/or container element(s) based at least in part on processing data aggregated by the data aggregation module 116. In at least one example, the relationship determination module 118 can determine containers followed by individual users 106. For the purpose of this discussion, a user 106 following a container can have a similar effect as a user 106 indicating that a container is a favorite container. In additional and/or alternative examples, the relationship determination module 118 can determine containers that are frequently accessed by a user 106. That is, the relationship determination module 118 can determine containers that a user 106 visits, interacts with, etc. a number of times above a threshold, at a rate above a threshold, etc. In at least one example, the relationship determination module 118 can determine containers that have been recently accessed by a user 106 based on a timestamp associated with an interaction. Furthermore, in at least one example, the relationship determination module 118 can determine containers that are frequently accessed by other users 106 associated with a user 106. That is, in some examples, the relationship determination module 118 can determine containers that users 106 who are associated with the user 106 have interacted with, without regard to whether the user 106 has interacted with the containers. Based at least in part on determining interactions between user(s) 106 and container(s), the relationship determination module 118 can determine or infer relationships between the user(s) 106 and the container(s).

Additionally and or alternatively, the relationship determination module 118 can determine relationships between user(s) 106 and container element(s) based at least in part on determining interactions between user(s) 106 and container element(s). In at least one example, the relationship determination module 118 can determine container elements followed, tagged, edited, shared, viewed, etc. by individual users 106. In additional and/or alternative examples, the relationship determination module 118 can determine container elements that are frequently accessed by a user 106. That is, the relationship determination module 118 can determine container elements that a user 106 visits, interacts with, etc. a number of times above a threshold, at a rate above a threshold, etc. In at least one example, the relationship determination module 118 can determine container elements that have been recently accessed by a user 106 based on a timestamp associated with an interaction. Furthermore, in at least one example, the relationship determination module 118 can determine container elements that are frequently accessed by other users 106 associated with a user 106. That is, in some examples, the relationship determination module 118 can determine container elements that users 106 who are associated with the user 106 have interacted with, without regard to whether the user 106 has interacted with the container elements. Based at least in part on determining interactions between user(s) 106 and container element(s), the relationship determination module 118 can determine or infer relationships between the user(s) 106 and the container el em ent(s).

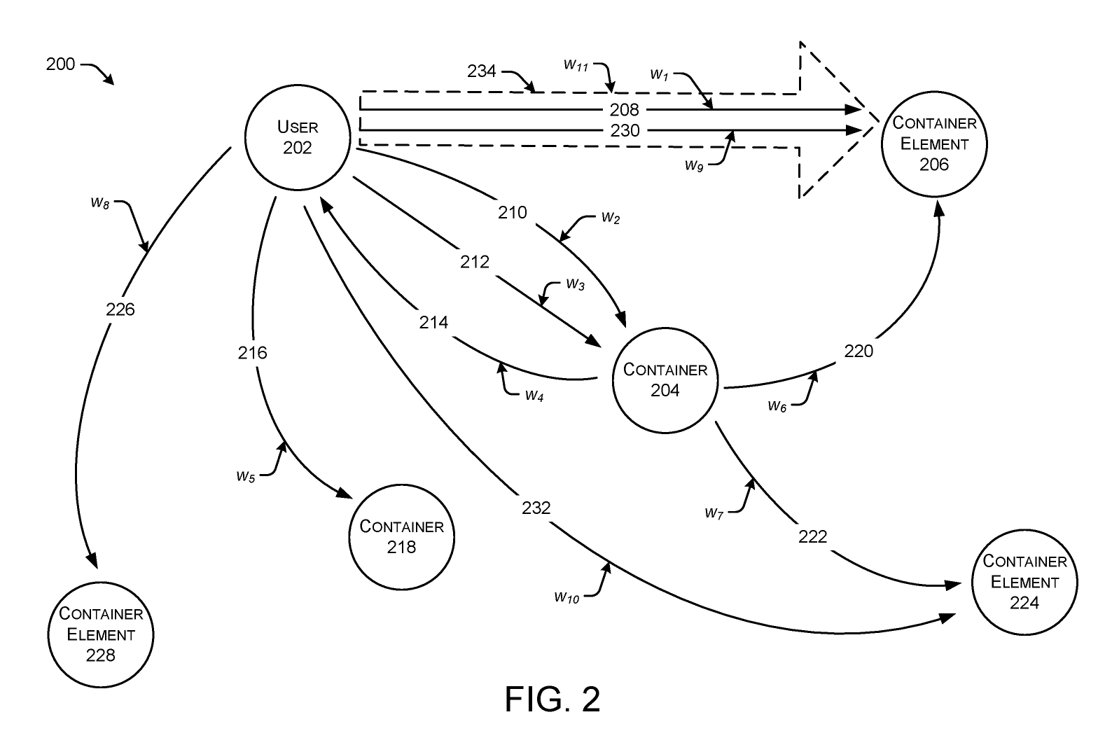

In at least one example, the relationship determination module 118 can determine weights associated with relationships between user(s) 106, container(s), and/or container element(s). The weights can represent a strength of a relationship between a user 106, a container, and/or a container element. In at least one example, the weights can be based at least in part on a frequency and/or regularity of interaction(s), a recency of interaction(s), etc. That is, a container with which a user 106 frequently interacts can have a higher weight than a container with which the user 106 does not frequently interact. Or, a container element that is frequently and/or regularly interacted with can have a higher weight than a container element that is infrequently and/or not regularly interacted with. Or, in a non-limiting example, a container with which a user 106 interacted with an hour ago can have a higher weight than a container with which a user 106 interacted with several days ago. In at least one example, a weight can correspond to relevance. Additional details associated with determining weights are described in FIG. 2, below.

The graph generation module 120 can generate data structures for representing relationships determined by the relationship determination module 118. In at least one example, a data structure can be a graph. A graph can include a plurality of objects, each representing a user 106, a container, or a container element. In at least one example, the objects can be nodes, vertices, or points. Individual objects of the plurality of objects can be connected by edges. Edges are lines, arcs, branches, etc. that connect two objects. Each object can have any number of edges connecting it to one or more other objects. Additional details associated with generating a graph are described below in FIG. 2. Additionally and/or alternatively, a data structure can be a matrix or any other data structure that can visually depict relationships between user(s) 106, container(s), and/or container element(s). The data structures can be stored in the database 124. In FIG. 1, graph(s) 128 are shown in the database 124.

As described above, in at least one example, the data aggregation module 116 can access the data that is stored in the user data 126 at a particular frequency, after a lapse in a period of time, after an occurrence of a particular event (e.g., accessing, receiving, determining new data, etc.), etc. Based at least in part on accessing updated data, the graph generation module 120 can update the data structure (e.g., graph 128) to reflect the changes based on the updated data.

As described above, in at least one configuration, the computer-readable media 114 of the server(s) 110 can include application(s) 122. The application(s) can facilitate generating user interface(s) for individual application(s) 122 that can be presented to user(s) 106 via device(s) 108 associated with the user(s) 106. The application(s) 122 can represent pieces of code executing on a computing device. In some examples, an application can include an Application Program Interface (API) to perform some or all of its functionality (e.g., operations). In additional and/or alternative examples, the application(s) 122 can be implemented as computer-readable instructions, various data structures, and so forth via at least one processing unit(s) (e.g., processor(s) 112) to configure a device to execute instructions and to perform operations for generating user interface(s) for individual application(s) 122 that can be presented to user(s) 106 via device(s) 108 associated with the user(s) 106. In at least one example, the application(s) 122 can access a data structure (e.g., graph(s) 128) and generate a user interface based at last in part on data associated with the data structure, as described herein. In an example, the user interface(s) can be configured to present interface elements representative of containers and container elements to a user 106 via a content page associated with a corresponding application 122 (e.g., a collaborative service application). A non-limiting example of a content page 150 is illustrated in FIG. 1. In at least one example, the content page can be a content feed configured to present user(s) 106 with frequently updated content. The user interface(s) can provide a user 106 with content corresponding to containers and/or container elements that the user 106 is likely going to want to access at a particular moment in time, as described above. In additional and/or alternative examples, the user interface(s) can include additional and/or alternative content such as images, videos, messages, widgets, etc.

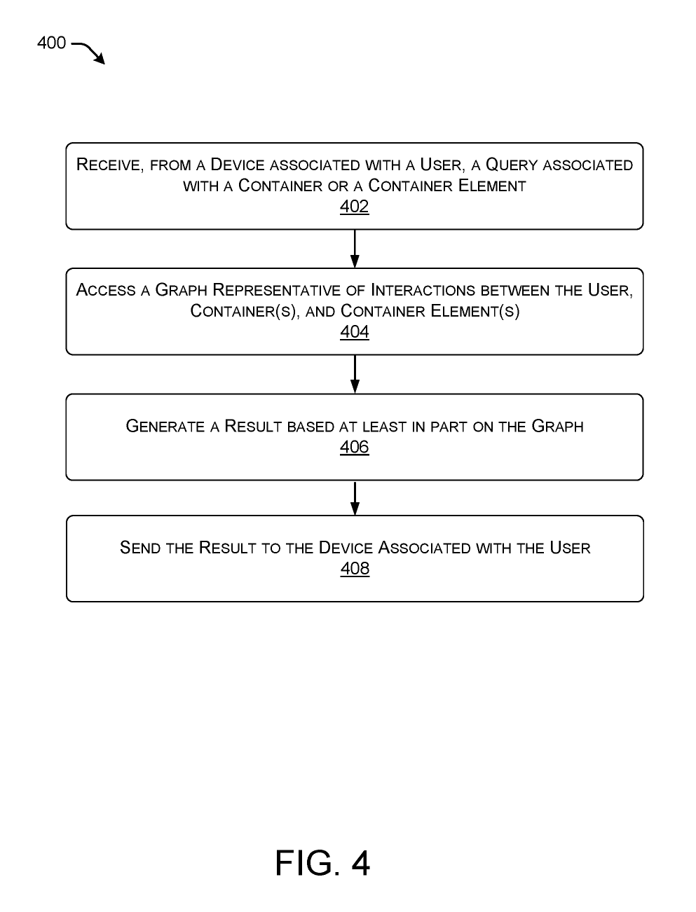

In an additional and/or alternative examples, the application(s) 122 can receive queries (e.g., search queries) from a device 108 associated with a user 106. The queries can be associated with container(s) and/or container element(s). The applications(s) 122 can access the database 124 to access the graph(s) 128 and can generate a result (e.g., search result) responsive to a query (e.g., search query) that based at least in part on the graph(s) 128. Additional details associated with generating results based at least in part on the graph(s) 128 is described below in FIG. 4.

The application(s) 122 can be built into a device (e.g., telecommunication, text message, clock, camera, etc.) or can be customized (e.g., games, news, transportation schedules, online shopping, etc.). The application(s) 122 can comprise any type of application that can facilitate collaboration between users 106, such as a content sharing application, a content synching application, or any other type of application.

The database 124 can store data that is organized so that it can be accessed, managed, and updated. In at least one example, the database 124 can store user data 126. As described above, user data 126 can be associated with data that can indicate interactions between user(s) 106, container(s), and/or container element(s). Additionally, the database 124 can store one or more data structures, such as graph(s) 128, generated by the graph generation module 120.

As described above, user(s) 106 can operate corresponding device(s) 108 (e.g., user devices) to perform various functions associated with the device(s) 108. The device(s) 108 can represent a diverse variety of device types and are not limited to any particular type of device. Examples of device(s) 108 can include but are not limited to stationary computers, mobile computers, embedded computers, or combinations thereof. Example stationary computers can include desktop computers, work stations, personal computers, thin clients, terminals, game consoles, personal video recorders (PVRs), set-top boxes, or the like. Example mobile computers can include laptop computers, tablet computers, wearable computers, implanted computing devices, telecommunication devices, automotive computers, portable gaming devices, media players, cameras, or the like. Example embedded computers can include network enabled televisions, integrated components for inclusion in a computing device, appliances, microcontrollers, digital signal processors, or any other sort of processing device, or the like.

Depending on the exact configuration and type of the server(s) 110, computer-readable media 114, can include computer storage media and/or communication media. Computer storage media can include volatile memory, nonvolatile memory, and/or other persistent and/or auxiliary computer storage media, removable and non-removable computer storage media implemented in any method or technology for storage of information such as computer readable instructions, data structures, program modules, or other data. Computer memory is an example of computer storage media. Thus, computer storage media includes tangible and/or physical forms of media included in a device and/or hardware component that is part of a device or external to a device, including but not limited to random-access memory (RAM), static random-access memory (SRAM), dynamic random-access memory (DRAM), phase change memory (PCM), read-only memory (ROM), erasable programmable read-only memory (EPROM), electrically erasable programmable read-only memory (EEPROM), flash memory, compact disc read-only memory (CD-ROM), digital versatile disks (DVDs), optical cards or other optical storage media, miniature hard drives, memory cards, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast, communication media can embody computer readable instructions, data structures, program modules, or other data in a modulated data signal, such as a carrier wave, or other transmission mechanism. The term “modulated data signal” means a signal that has one or more of its characteristics set or changed in such a manner as to encode information in the signal. Such signals or carrier waves, etc. can be propagated on wired media such as a wired network or direct-wired connection, and/or wireless media such as acoustic, RF, infrared and other wireless media. As defined herein, computer storage media does not include communication media. That is, computer storage media does not include communications media consisting solely of a modulated data signal, a carrier wave, or a propagated signal, per se.

FIG. 2 is a schematic diagram that illustrates an example of a data structure that can be generated to define relationships between user(s), container(s), and/or container element(s). As described above, the graph generation module 120 can generate data structures for representing relationships determined by the relationship determination module 118. A non-limiting example of a data structure is graph 200, as illustrated in FIG. 2. Graph 200 can be stored in database 124 with graph(s) 128. As described above, a data structure can alternatively be a matrix or any other data structure that can visually depict relationships between user(s) 106, container(s), and/or container element(s).

A graph, such as graph 200, can include a plurality of objects (e.g., 202, 204, 206, etc.). Individual objects can represent a user 106 (e.g., object 202), a container (e.g., object 204), or a container element (e.g., object 206). In at least one example, the objects can be nodes, vertices, or points, as described above. Individual objects of the plurality of objects can be connected by edges (e.g., 208, 210, 212, etc.), as described above. The graph generation module 120 can leverage weights associated with the relationships between user(s) 106, container(s), and/or container element(s) to determine edges. Additionally and/or alternatively, the graph generation module 120 can leverage permissions data associated with the user(s) 106, container(s), and/or container element(s) to determine edges, as described below.

Edge 208 represents a relationship between a user 106, represented by object 202, and a container element, represented by object 206. The graph generation module 120 can add edge 208 to the graph 200 based at least in part on user data 124 indicating that a user 106 interacted with the container element via an action. For instance, edge 208 can indicate that the user 106 followed, tagged, modified, viewed, and/or shared the container element. That is, the graph generation module 120 can add edge 208 to the graph 200 based at least in part on an explicit action between the user 106 and the container element.

In at least one example, edge 208 can be associated with a weight w₁ determined by the relationship determination module 118. The weight can correspond to a relationship represented by the edge 208. In at least one example, the relationship can be associated with one or more interactions between the user 106 and the container element. In such examples, each interaction of the one or more interactions can be associated with a weight and weights associated with each of the interactions can be combined to determine the weight associated with the relationship, as described below.

In some examples, an interaction associated with the relationship corresponding to edge 208 can be associated with a weight that can be based at least in part on a timestamp. For instance, a recent interaction can have a higher weight than a less recent interaction (i.e., the weight decreases based on an amount of lapsed time). As a non-limiting example, the relationship determination module 118 can assign a weight closer to one to an interaction that occurred minutes ago and a weight closer to zero to an interaction that occurred weeks or months ago.

In other examples, an interaction associated with the relationship corresponding to edge 208 can be associated with a weight that can be based at least in part on the action associated with the interaction. For instance, particular actions performed on or associated with a container element can indicate that a user 106 is more interested in that container element than another container element associated with a different action. As a non-limiting example, an action where a user 106 authored, uploaded, shared, or edited a container element can have a higher weight (e.g., closer to one) than an action where a user 106 viewed a container element (e.g., closer to zero).

In at least one example, the weights associated with the actions can be determined using machine learning algorithms. Machine learning algorithms can include supervised learning algorithms (e.g., artificial neural networks, Bayesian statistics, support vector machines, decision trees, classifiers, k-nearest neighbor, etc.), unsupervised learning algorithms (e.g., artificial neural networks, association rule learning, hierarchical clustering, cluster analysis, etc.), semi-supervised learning algorithms, deep learning algorithms, etc. The machine learning algorithms can access data associated with the user(s) 106 (e.g., user data 126) identifying with interactions between user(s) 106, container(s), and/or container element(s). The machine learning algorithms can learn which actions lead to a user 106 returning to a container element in a shortest amount of time. Such actions can be associated with a highest weight (e.g., closer to one). The machine learning algorithms can also learn which actions lead to a user 106 slowly returning to a container element (e.g., in an amount of time outside of a predetermined range or threshold), or never returning to the container element. Such actions can be associated with a lowest weight (e.g., closer to zero).

In at least one example, the machine learning algorithms can be trained based at least in part on clicks indicating selection of a container element (or a container element). For instance, the relationship determination module 118 can collect data associated with the clicks over a period of time and can train the machine learning algorithms on the data associated with the clicks. The trained machine learning algorithms can be iteratively trained to predict which actions lead to a user 106 clicking on a container element (or a container) in a shortest amount of time.

In some examples, an interaction associated with the relationship corresponding to edge 208 can be associated with a weight that can be based at least in part on the timestamp and the action. For instance, the weight can be a sum of the weight associated with the timestamp and the weight associated with the action. Or, the weight can be an average (mean), median, mode, or other measure of central tendency, or another computation associated with the weights associated with the timestamp and the action. In other examples, the timestamp weight or the weight associated with the action can be weighted more than the other weight. For instance, in some examples, a weight associated with a timestamp can affect the weight associated with the interaction more than a weight associated with the action. In at least one example, machine learning algorithms can be used to determine the weights associated with each interaction, as described above.

As described above, in at least one example, edge 208 can represent a relationship between the user 106 and a container element that can be associated with two or more interactions between the user 106 and the container element. In such examples, the relationship determination module 118 can leverage the weights determined for each interaction between a user 106 and a same container element to determine the weight associated with edge 208. That is, the weight associated with the edge 208 can be representative of multiple interactions between the user 106 and the container element. In some examples, the weight associated with the relationship can be a sum of weights associated with each interaction. In other examples, the weight associated with the relationship can be an average (mean), median, mode, or other measure of central tendency of the weights associated with each interaction. Additional and/or alternative computations can be utilized to determine the weight associated with the relationship based on the weights associated with one or more interactions.

A non-limiting example of an equation that can be used to determine a weight based on timestamp(s) and action(s) associated with one or more interactions is shown below in EQUATION 1. In EQUATION 1, λ′_{ud} can represent the weight of relationship between a user u and a container element d. In such examples, λ_{ud} can estimate a rate of interaction between the user u and the container element d. β^{τ} can represent a time decay factor (i.e., how much the rate of interaction decreases during a time τ). vₐ can represent the weight of the action associated with the interaction (e.g., view, edit, tag, share, etc.). c_{aud} can represent a number of interactions of type a between a user u and a container element d in a given a time τ.

$${λ}_{ud}^{′} = {β}^{τ} {λ}_{ud} + ( 1 - {β}^{τ} ) {\sum }_{a} {v}_{a} \frac{{c}_{aud}}{τ} \qquad EQUATION 1$$

The relationship determination module 118 can rank relationships between the user 106 and various container elements such that a relationship with a highest weight is ranked first and a relationship with a lowest weight is ranked last. In some examples, the graph generation module 120 can add edge 208 to the graph 200 if the weight associated with the relationship is a top ranked weight or within a predetermined number of top ranked weights. Or, the graph generation module 120 can add edge 208 to the graph 200 if the weight associated with the relationship is above a threshold weight. The graph generation module 120 can refrain from adding an edge 208 to the graph 200 if the weight associated with the relationship is not a top ranked weight or within a predetermined number of top ranked weights, or is below a threshold weight.

The relationship determination module 118 can update the weights at a particular frequency, after a lapse in a period of time, after an occurrence of a particular event (e.g., accessing, receiving, determining new data, etc.), etc. In some examples, the edge 208 can persist in the graph 200 until the weight associated with the relationship represented by edge 208 falls below the threshold weight or outside of the top ranked relationship(s). In additional and/or alternative examples, the graph generation module 120 can add edge 208 to the graph 200, and the edge 208 can persist in the graph 200, without regard to a corresponding weight or rank, and the application(s) 122 can leverage the weights for generating the user interface, as described herein.

Edge 210 can represent a relationship between a user 106, represented by object 202, and a container, represented by object 204. More specifically, edge 210 can represent that a user 106 has explicitly followed the container. That is, the graph generation module 120 can determine edge 210 based at least in part on user data 124 indicating that a user 106 followed the container. In at least one example, a user 106 can indicate that he or she desires to follow the container by an interaction with the container via a user interface (e.g., a content page associated with a collaborative service application, etc.). For instance, a user 106 can actuate a control associated with a graphical representation corresponding to the container on the user interface. Or, a user can 106 can otherwise interact with the user interface to indicate that he or she desires to follow the container (e.g., speech input, gaze input, gesture input, etc.).

Edge 210 can be associated with a weight w₂ that can be based on a timestamp associated with a time that the user 106 indicated that he or she is following the container. The weight can be larger (e.g., closer to one) for containers recently followed, as determined by the timestamp. That is, the weight can decrease over time. The more time that has lapsed between when the user 106 follows a container and a current time, the smaller the weight associated with edge 210. Edge 210 can persist in the graph until a user 106 unfollows a container, or the weight is determined to be below a predetermined threshold weight.

Edge 212 can represent a relationship between a user, represented by object 202, and a container, represented by object 204. The relationship determination module 118 can determine the relationship corresponding to edge 212 based at least in part on user data 126 indicating that the user 106 accessed the container, interacted with the container, etc. Edge 212 can represent a relationship indicating that the container is frequently and/or recently accessed by the user 106. That is, the relationship determination module 118 can determine that the user 106 visits the container, interacts with the container, etc. a number of times above a threshold, at a rate above a threshold, etc. Additionally and/or alternatively, the relationship determination module 118 can determine that a user 106 recently accessed a container based at least in part on the timestamp.

Relationships represented by edge 212 can be associated with a weight w₃ determined by the relationship determination module 118. In some examples, an interaction associated with the relationship corresponding to edge 212 can be associated with a weight that can be based at least in part on a timestamp and/or an action, as described above in the context of edge 208. In at least one example, edge 212 can represent a relationship between the user 106 and the container that is associated with two or more interactions between the user 106 and the container. In such examples, the relationship determination module 118 can leverage the weights determined for each interaction between a user 106 and a same container to determine a weight associated with edge 212. The weight associated with the relationship between the user 106 and the container can be representative of multiple interactions between the user 106 and the container, as described above in the context of edge 208.

In at least one example, the relationship determination module 118 can determine weights associated with each container with which a user 106 has interacted. The relationship determination module 118 can rank relationships between the user 106 and each container such that a relationship with a highest weight is ranked first and a relationship with a lowest weight is ranked last. In some examples, the graph generation module 120 can add edge 212 to the graph 200 if the weight associated with the relationship is a top ranked weight or within a predetermined number of top ranked weights. Or, the graph generation module 120 can add edge 212 to the graph 200 if the weight associated with the relationship is above a threshold weight. The graph generation module 120 can refrain from adding an edge 212 to the graph 200 if the weight associated with the relationship is not a top ranked weight or within a predetermined number of top ranked weights, or is below a threshold weight.

The relationship determination module 118 can update the weights at a particular frequency, after a lapse in a period of time, after an occurrence of a particular event (e.g., accessing, receiving, determining new data, etc.), etc. In some examples, the edge 212 can persist in the graph 200 until the weight associated with the relationship represented by edge 212 falls below the threshold weight or outside of the top ranked relationship(s). In additional and/or alternative examples, the graph generation module 120 can add edge 212 to the graph 200, and the edge 212 can persist in the graph 200, without regard to a corresponding weight or rank, and the application(s) 122 can leverage the weights for generating the user interface, as described herein.

Edge 214 can represent a relationship between a user 106, represented by object 202, and a container, represented by object 204. More specifically, edge 214 can represent a relationship indicating that a user 106 frequently accesses and/or recently accessed the container. One or more edges representing a same relationship as edge 214 can extend from an object representing a container (e.g., object 204) to objects representing one or more users 106 that are frequently interacting with the container and/or have recently interacted with the container. That is, edge 214 can indicate that the user 106 is a top contributor to the container such that the user 106 is frequently and/or recently interacting with the container.

Relationships represented by edge 214 can be associated with a weight w₄ determined by the relationship determination module 118, as described above. With respect to edge 214, in at least one example, the relationship determination module 118 can determine weights associated with relationships between users 106 that have interacted with a container and the container. In at least one example, the weight associated with edge 214 can be the same weight as the weight associated with edge 212. That is, in such an example, w₄=w₃.

The relationship determination module 118 can rank the relationships such that a relationship with a highest weight is ranked first and a relationship with a lowest weight is ranked last. In some examples, the graph generation module 120 can add edge 214 to the graph 200 if the weight associated with the relationship is a top ranked weight or within a number of top ranked relationships. Or, the graph generation module 120 can add edge 214 to the graph 200 if the weight associated with the relationship is above a threshold weight. The graph generation module 120 can refrain from adding an edge 214 to the graph 200 if the weight associated with the relationship is not a top ranked weight or within a predetermined number of top ranked weights, or is below a threshold weight.

The relationship determination module 118 can update the weights at a particular frequency, after a lapse in a period of time, after an occurrence of a particular event (e.g., accessing, receiving, determining new data, etc.), etc. In some examples, the edge 214 can persist in the graph 200 until the weight associated with the relationship represented by edge 214 falls below a threshold or outside of the range of top ranked relationships. In additional and/or alternative examples, the graph generation module 120 can add edge 214 to the graph 200, and the edge 214 can persist in the graph 200, without regard to a corresponding weight or rank, and the application(s) 122 can leverage the weights for generating the user interface, as described herein.

Edge 216 can represent a relationship between a user, represented by object 202, and a container, represented by object 218. More specifically, edge 216 can represent a relationship between the user 106 and the container based at least in part on the container being frequently accessed by the other users 106 (e.g., friends, colleagues, team members, group members, etc.) that are associated with the user 106. As described above, in some examples, the relationship determination module 118 can infer relationships between users 106 and containers and/or container elements. The relationship determination module 118 can infer a relationship corresponding to edge 216 based at least in part on user data 126 indicating that the other users 106 that are associated with the user 106 accessed the container, interacted with the container, etc. In at least one example, the user 106 may not have interacted with the container.

Relationships represented by edge 216 can be associated with a weight w₅ determined by the relationship determination module 118. The weight associated with edge 216 can be based at least in part on weight(s) associated with one or more individual interactions between the one or more users 106 associated with the user 106 and the container. The weight(s) associated with the one or more individual interactions can be based at least in part on a timestamp and/or an action associated with the one or more individual interactions, as described above in the context of edge 208.

Additionally and/or alternatively, the weight(s) can be based at least in part on relationship(s) between the user 106 and the other user(s) 106 interacting with the container. For instance, an interaction between a first user 106 who is determined to be more closely related to the user 106 (e.g., a family member, a team member, etc.) and a container can be associated with a higher weight than an interaction between a second user 106 who is determined to be less closely related to the user 106 (e.g., an acquaintance, an employee for a same company who is not a team member, etc.) and the container. In at least one example, the weight associated with the user(s) 106 who are not the user 106 can be less than one, or another value to cause inferred relationships to be associated with weights that are less than weights associated with explicit relationships. In such examples, the weight associated with the user(s) 106 who are not the user 106 can have a value that is less than one that depends on the strength of the relationship with the user 106. For instance, an interaction between a first user 106 who is determined to be more closely related to the user 106 (e.g., a family member, a team member, etc.) and a container can be associated with a weight closer to one than an interaction between a second user 106 who is determined to be less closely related to the user 106 (e.g., an acquaintance, an employee for a same company who is not a team member, etc.) and the container. In such an example, the interaction between the second user 106 who is determined to be less closely related to the user 106 (e.g., an acquaintance, an employee for a same company who is not a team member, etc.) and the container can be associated with a weight closer to zero.

The relationship determination module 118 can rank relationships between the user 106 and various containers such that a relationship with a highest weight is ranked first and a relationship with a lowest weight is ranked last. In at least one example, the relationship determination module 118 can rank inferred relationship(s) corresponding to edge 216 and edges similar to edge 216 separately. That is, the relationship module 118 can rank relationship(s) between a user 106 and a container that he or she hasn't accessed and/or interacted with separate from relationship(s) between the user 106 and a container that he or she has accessed and/or interacted with. In other examples, the relationship determination module 118 can rank the relationship(s) between the user 106 and the containers collectively, without regard to whether the user 106 has accessed a container.

In some examples, the graph generation module 120 can add edge 216 to the graph 200 if the weight associated with the relationship is a top ranked weight or within a predetermined number of top ranked weights. Or, the graph generation module 120 can add edge 216 to the graph 200 if the weight associated with the relationship is above a threshold weight. Additionally and/or alternatively, the graph generation module 120 can access permissions data associated with the user 106 to determine whether the user 106 has access to the container (e.g., the container represented by object 218). Based at least in part on determining that the user 106 has access to the container, the graph generation module 120 can add edge 216 to the graph 200. However, based at least in part on determining that the user 106 does not have access to the container, the graph generation module 120 can refrain from adding edge 216 to the graph 200. Furthermore, the graph generation module 120 can refrain from adding an edge 216 to the graph 200 if the weight associated with the relationship is not a top ranked weight or within a predetermined number of top ranked weights, or is below a threshold weight.

The relationship determination module 118 can update the weights at a particular frequency, after a lapse in a period of time, after an occurrence of a particular event (e.g., accessing, receiving, determining new data, etc.), etc. In some examples, the edge 216 can persist in the graph 200 until the weight associated with the relationship represented by edge 216 falls below the threshold weight or outside of the top ranked relationship(s). In additional and/or alternative examples, the graph generation module 120 can add edge 216 to the graph 200, and the edge 216 can persist in the graph 200, without regard to a corresponding weight or rank, and the application(s) 122 can leverage the weights for generating the user interface, as described herein.

Edges 220 and 222 can represent relationships between a container, represented by object 204, and a first container element, represented by object 206, and a second container element, represented by object 224, respectively. More specifically, edges 220 and 222 can each represent a relationship between the container and the respective container element based at least in part on each of the container elements being frequently accessed by various user(s) 106. That is, the relationship determination module 118 can determine container elements that user(s) 106 visit, interact with, etc. a number of times above a threshold, at a rate above a threshold, etc. In at least one example, edges 220 and 222 are not specific to individual users 106. Instead, edges 220 and 222 identify which container elements are the most active container elements associated with the container. That is, edges 220 and 222 identify which container elements are most frequently viewed, shared, modified, tagged, etc. container elements associated with the container.

In at least one example, edge 220 and/or edge 222 can each be associated with a weight w₆ and w₇, respectively, determined by the relationship determination module 118. The weight corresponding to each edge (e.g., edge 220 or edge 222) can correspond to a relationship represented by the edge. In at least one example, the relationship can be associated with one or more interactions between user(s) 106 and the corresponding container element. With respect to edge 220, in some examples, an interaction associated with the relationship corresponding to edge 220 can be associated with a weight w₆ that can be based at least in part on a timestamp and/or an action, as described above in the context of edge 208. As described above, in at least one example, edge 220 can represent a relationship between the container and the corresponding container element that can be associated with two or more interactions between user(s) 106 and the container element. In such examples, the relationship determination module 118 can leverage the weights determined for each interaction between a user 106 and the container element to determine the weight associated with edge 220. That is, the weight associated with the edge 220 can be representative of multiple interactions between user(s) 106 and the container element, as described above in the context of edge 208. A weight w₇ associated with edge 222 can be determined via a process similar to the process described above for edge 220.

The relationship determination module 118 can rank relationships between the container and the container elements such that a relationship with a highest weight is ranked first and a relationship with a lowest weight is ranked last. In some examples, the graph generation module 120 can add edge 220 and/or edge 222 to the graph 200 if the weight associated with each respective relationship is a top ranked weight or within a predetermined number of top ranked weights. Or, the graph generation module 120 can add edge 220 and/or edge 222 to the graph 200 if the weight associated with each respective relationship is above a threshold weight. The graph generation module 120 can refrain from adding an edge 220 and/or edge 222 to the graph 200 if the weight associated with the relationship is not a top ranked weight or within a predetermined number of top ranked weights, or is below a threshold weight.

The relationship determination module 118 can update the weights at a particular frequency, after a lapse in a period of time, after an occurrence of a particular event (e.g., accessing, receiving, determining new data, etc.), etc. In some examples, edge 220 and/or edge 222 can persist in the graph 200 until the weights associated with the relationships represented by edge 220 and/or edge 222 fall below the threshold weight or outside of the top ranked relationship(s). In additional and/or alternative examples, the graph generation module 120 can add edge 220 and/or edge 222 to the graph 200, and edge 220 and/or edge 222 can persist in the graph 200, without regard to a corresponding weight or rank, and the application(s) 122 can leverage the weights for generating the user interface, as described herein.

Edge 226 can represent a relationship between a user, represented by object 202, and a container element, represented by object 228. More specifically, edge 226 can represent a relationship between the user 106 and the container element based at least in part on the container element being frequently accessed by the other user(s) 106 that are associated with the user 106. As described above, in some examples, the relationship determination module 118 can infer relationships between users 106 and containers and/or container elements. The relationship determination module 118 can infer a relationship associated with edge 226 based at least in part on user data 126 indicating that the other user(s) 106 that are associated with the user 106 accessed the container element, interacted with the container element, etc. In at least one example, the user 106 may not have interacted with the container element.

Relationships represented by edge 226 can be associated with a weight w₈ determined by the relationship determination module 118. The weight associated with edge 226 can be based at least in part on weight(s) associated with one or more individual interactions between the one or more users 106 associated with the user 106 and a container element (e.g., container represented by object 228). The weight(s) associated with the one or more individual interactions can be based at least in part on timestamp(s) and/or action(s) associated with the one or more individual interactions, as described above in the context of edge 208.

Additionally and/or alternatively, the weight(s) can be based at least in part on relationship(s) between the user 106 and the other user(s) 106 interacting with the container element. For instance, an interaction between a first user 106 who is determined to be more closely related to the user 106 (e.g., a family member, a team member, etc.) and a container element can be associated with a higher weight than an interaction between a second user 106 who is determined to be less closely related to the user 106 (e.g., an acquaintance, an employee for a same company who is not a team member, etc.) and the container element. In at least one example, the weight associated with the user(s) 106 who are not the user 106 can be less than one, or another value to cause inferred relationships to be associated with weights that are less than weights associated with explicit relationships. In such examples, the weight associated with the user(s) 106 who are not the user 106 can have a value that is less than one that depends on the strength of the relationship with the user 106. For instance, an interaction between a first user 106 who is determined to be more closely related to the user 106 (e.g., a family member, a team member, etc.) and a container element can be associated with a weight closer to one than an interaction between a second user 106 who is determined to be less closely related to the user 106 (e.g., an acquaintance, an employee for a same company who is not a team member, etc.) and the container element. In such an example, the interaction between the second user 106 who is determined to be less closely related to the user 106 (e.g., an acquaintance, an employee for a same company who is not a team member, etc.) and the container element can be associated with a weight closer to zero.

The relationship determination module 118 can rank relationships between the user 106 and various container elements such that a relationship with a highest weight is ranked first and a relationship with a lowest weight is ranked last. In at least one example, the relationship determination module 118 can rank inferred relationship(s) corresponding to edge 226 and edges similar to edge 226 separately. That is, the relationship module 118 can rank relationship(s) between a user 106 and a container element that he or she hasn't accessed and/or interacted with separate from relationship(s) between the user 106 and a container element that he or she has accessed and/or interacted with. In other examples, the relationship determination module 118 can rank the relationship(s) between the user 106 and the container elements collectively, without regard to whether the user 106 has accessed a container element.

In some examples, the graph generation module 120 can add edge 226 to the graph 200 if the weight associated with the relationship is a top ranked weight or within a predetermined number of top ranked weights. Or, the graph generation module 120 can add edge 226 to the graph 200 if the weight associated with the relationship is above a threshold weight. Additionally and/or alternatively, the graph generation module 120 can access permissions data associated with the user 106 to determine whether the user 106 has access to the container element (e.g., the container element represented by object 228). Based at least in part on determining that the user 106 has access to the container element, the graph generation module 120 can add edge 226 to the graph 200. However, based at least in part on determining that the user 106 does not have access to the container element, the graph generation module 120 can refrain from adding edge 226 to the graph 200. Furthermore, the graph generation module 120 can refrain from adding an edge 226 to the graph 200 if the weight associated with the relationship is not a top ranked weight or within a predetermined number of top ranked weights, or is below a threshold weight.

The relationship determination module 118 can update the weights at a particular frequency, after a lapse in a period of time, after an occurrence of a particular event (e.g., accessing, receiving, determining new data, etc.), etc. In some examples, the edge 226 can persist in the graph 200 until the weight associated with the relationship represented by edge 226 falls below the threshold weight or outside of the top ranked relationship(s). In additional and/or alternative examples, the graph generation module 120 can add edge 226 to the graph 200, and the edge 226 can persist in the graph 200, without regard to a corresponding weight or rank, and the application(s) 122 can leverage the weights for generating the user interface, as described herein.

Edges 230 and 232 represent relationships between a user 106, represented by object 202, and container elements, represented by object 206 and object 224, respectively. Edge 230 can represent a relationship that can be inferred by the relationship determination module 118 between the user 106 and the container element represented by object 206 based at least in part on the relationships represented by edge 212 (e.g., container frequently accessed by user 106) and edge 220 (e.g., the container element being an active container element associated with the container). Additionally and/or alternatively, edge 232 can represent a relationship that can be inferred between the user 106 and the container element, represented by object 224 based at least in part on the relationships represented by edge 212 (e.g., container frequently accessed by user 106) and edge 222 (e.g., the container element being an active container element associated with the container). A user 106 need not have directly interacted with the container element for an edge, such as edge 232, to be added to the graph 200.

Relationships represented by edge 230 and edge 232 can be associated with weights w₉ and w₁₀, respectively, determined by the relationship determination module 118. In at least one example, the weight w₉ corresponding to edge 230 can be determined by the relationship determination module 118 based at least in part on the weight w₃ corresponding to edge 212 and the weight w₆ corresponding to edge 220. The weight w₁₀ corresponding to edge 232 can be determined by the relationship determination module 118 based at least in part on the weight w₃ corresponding to edge 212 and the weight w₇ corresponding to edge 222. In some examples, the weight for each edge 230 and/or edge 232 can be a sum of the weights associated with edge 212 and edge 220 or edge 212 and edge 222, respectively. That is, in at least one example, w₉=w₃+w₆ and w₁₀=w₃+w₇. In other examples, the weight can be an average (mean), median, mode, or other measure of central tendency of the weights associated with edge 212 and edge 220 or edge 212 and edge 222, respectively. That is, in at least one non-limiting example, w₉=(w₃+w₆)/2 and w₁₀=(w₃+w₇)/2. Additional and/or alternative combinations of the weights associated with individual relationships can be used to determine the weights associated with edge 230 and edge 232.

The relationship determination module 118 can rank relationships between the user 106 and various container elements such that a relationship with a highest weight is ranked first and a relationship with a lowest weight is ranked last. In some examples, the graph generation module 120 can add edge 230 and/or edge 232 to the graph 200 if the weight associated with each corresponding relationship is a top ranked weight or within a predetermined number of top ranked weights. Or, the graph generation module 120 can add edge 230 and/or edge 232 to the graph 200 if the weight associated with each corresponding relationship is above a threshold weight. Additionally and/or alternatively, the graph generation module 120 can access permissions data associated with the user 106 to determine whether the user 106 has access to a corresponding container element (e.g., the container element represented by object 206 or object 228). Based at least in part on determining that the user 106 has access to the container element, the graph generation module 120 can add edge 230 and/or edge 232 to the graph 200. However, based at least in part on determining that the user 106 does not have access to the container element, the graph generation module 120 can refrain from adding edge 230 and/or edge 232 to the graph 200. Furthermore, the graph generation module 120 can refrain from adding an edge 230 and/or edge 232 to the graph 200 if the weight associated with the relationship is not a top ranked weight or within a predetermined number of top ranked weights, or is below a threshold weight.

The relationship determination module 118 can update the weights at a particular frequency, after a lapse in a period of time, after an occurrence of a particular event (e.g., accessing, receiving, determining new data, etc.), etc. In some examples, edge 230 and/or edge 232 can persist in the graph 200 until the weight associated with the relationships represented by edge 230 and/or edge 232 falls below the threshold weight or outside of the top ranked relationship(s). In additional and/or alternative examples, the graph generation module 120 can add edge 230 and/or edge 232 to the graph 200, and edge 230 and/or edge 232 can persist in the graph 200, without regard to a corresponding weight or rank, and the application(s) 122 can leverage the weights for generating the user interface, as described herein.

In at least one example, a weight associated with the relationship between a user 106 and a container element that he or she has previously interacted with (e.g., container element represented by object 206) can be based at least in part on the weight associated a previous interaction. For instance, in FIG. 2, the weight w₁₁ associated with the relationship between object 202 and object 206 can be based at least in part on the weights associated with edge 208 (w₁) and edge 230 (w₉). Accordingly, a weight associated with the relationship between a user 106 and a container element that he or she has previously interacted with (e.g., container element represented by object 206) can be greater than the weight associated with the relationship between the user 106 and a container element that he or she has not previously interacted with (e.g., container element represented by object 224). As such, in at least one example, the container element represented by object 206 can be determined to be more relevant to the user 106 than the container element represented by object 224 based at least in part on the weight w₁₁ associated with the relationship between the user 106 and the container element represented by object 206 being greater than the weight w₁₀ of the relationship associated with edge 232. In at least one example, the graph generation module 120 can replace edge 208 and edge 230 with a single edge 234 that represents both the explicit (e.g., edge 208) and inferred (e.g., edge 230) relationship as a single relationship. As a result, in at least one example, the container element associated with object 206 may be presented before the container element associated with object 224 in a user interface presented to the user 106.

As described above, in some examples, a weight associated with a relationship between a user 106 and a container or a container element can be determined based on weights associated with individual interactions between a user 106 and a same container or a same container element. Or, a relationship between a container and a container element can be determined based on weights associated with individual interactions between the container and the container element. As described above, the weights associated with the individual interactions can be used to determine the weight associated with the relationship. In additional and/or alternative examples, the weights associated with the individual interactions can be used to determine which interaction to surface in association with an interface element corresponding to a container element in a user interface.

### Example Processes

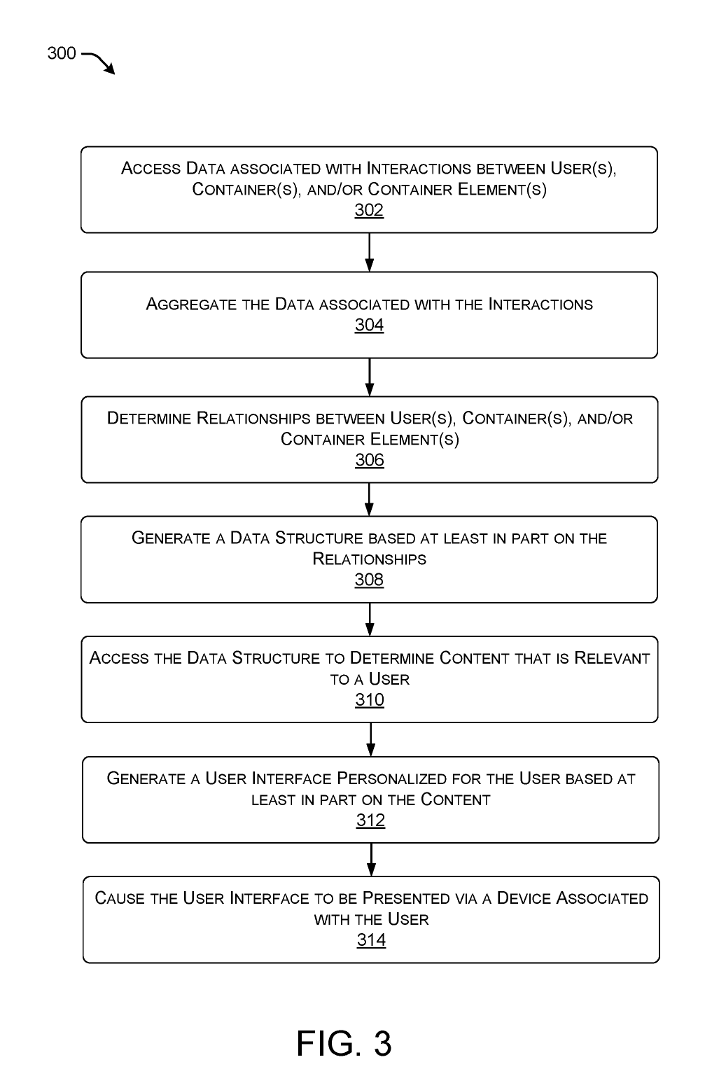

The processes described in FIGS. 3 and 4 below are illustrated as a collection of blocks in a logical flow graph, which represent a sequence of operations that can be implemented in hardware, software, or a combination thereof. In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes.

FIG. 3 is a flow diagram that illustrates an example process 300 to generate a user interface that is personalized for a user 106 based at least in part on a data structure that represents relationships between user(s) 106, container(s), and/or container element(s).

Block 302 illustrates accessing data associated with interactions between user(s) 106, container(s), and/or container element(s). The data aggregation module 116 can receive, access, or determine data from local storage associated with the device(s) 108 and/or service provider 102 (e.g., user data 126), remote storage repositories associated with the device(s) 108 and/or the service provider 102, and/or third party sources or systems. The data can indicate interactions between user(s) 106, container(s), and/or container element(s), as described above.

Block 304 illustrates aggregating the data associated with the interactions. The data aggregation module 116 can aggregate data associated with interactions between user(s) 106, container(s), and/or container element(s), as described above.

Block 306 illustrates determining relationships between user(s) 106, container(s), and/or container element(s). The relationship determination module 118 can determine relationships between user(s) 106, container(s), and/or container element(s) based at least in part on processing data aggregated by the data aggregation module 116, as described above. In at least one example, the relationship determination module 118 can determine weights associated with relationships between user(s) 106, container(s), and/or container element(s). Additional details associated with determining weights are described in FIG. 2, above. The weights can correspond to relevance, as described above.

Block 308 illustrates generating a data structure based at least in part on the relationships. The graph generation module 120 can generate data structures for representing relationships determined by the relationship determination module 118, as described above. In at least one example, a data structure can be a graph (e.g., graph 200). Additional details associated with generating a graph are described above in FIG. 2. Additionally and/or alternatively, a data structure can be a matrix or any other data structure that can visually depict relationships between user(s) 106, container(s), and/or container element(s). As described above, the data structures can be stored in the database 124, such as graph(s) 128.

Block 310 illustrates accessing the data structure to determine content that is relevant to a user 106. In at least one example, an application of the application(s) 122 can access the database 124 to access the graph(s) 128 for generating a user interface based at least in part on the graph(s) 128. In an example where the data structure is a graph (e.g., graph 200), the application can locate an object associated with the user 106. The application can identify relationships between the user 106 and various containers and/or container elements based at least in part on transitive closure of the graph. Furthermore, the application can determine which content is relevant to a user 106 based at least in part on the weights associated with the relationships, described above. In at least some examples, the process for determining which content is relevant to a user 106 can depend on whether the user 106 has previously accessed the content.

In at least one example, the application can determine one or more containers that are relevant to a user 106, as described below. Based at least in part on identifying one or more containers that are relevant to the user 106, the application can identify one or more container elements associated with each container of the one or more containers that are relevant to the user 106. In some examples, the one or more containers or one or more container elements can be containers or container elements that the user 106 has previously accessed. In at least one example, one or more of the containers or one or more of the container elements can be containers or container elements that are frequently accessed by user(s) 106 associated with the user 106. Additional details are provided below.

To determine containers that are relevant to a user 106, the application can locate an object associated with the user 106 (e.g., object 202). The application can identify relationships between the user 106 and various containers. In at least one example, the application can identify the relationships between the user 106 and the various containers via transitive closure of the graph. That is, the application can determine other objects that correspond to containers that are reachable from the object associated with the user 106 via an edge (e.g., edge 210, edge 212, edge 216). In some examples, the user 106 may have previously accessed a container (e.g., container associated with object 204) identified via transitive closure of the graph. In other examples, the user 106 may have not previously accessed the container (e.g., container associated with object 218).

In at least one example, the application can determine each of the containers with which the user 106 has a relationship, as represented in the graph. In an example, the application can leverage the weights associated with each relationship to determine which containers are relevant to the user 106. In some examples, the application can determine that a container with which the user 106 has a relationship that is associated with a weight above a threshold weight is a relevant container. The application can select one or more containers that correspond to a relationship with a weight above a threshold weight as relevant containers. In at least one example, the application can rank each of the containers in the one or more containers based at least in part on the weight associated with the relationship with the user 106. That is, all of the containers in the one or more containers can be relevant to the user 106, but the container corresponding to a relationship with a highest weight can be the most relevant to the user 106. In at least one example, the number of relevant containers selected can be determined by a size and/or arrangement of a user interface and the ranking can correspond to a position on the user interface.

In additional and/or alternative examples, the application can rank the containers such that a top ranking container can be associated with a relationship having a largest weight and a bottom ranking container can be associated with a relationship having a smallest weight. In such examples, the application can select a top ranking container or a group of top ranking containers as relevant content. In at least one example, the number of relevant containers in the group can be determined by a size and/or arrangement of a user interface and the ranking can correspond to a position on the user interface.

In at least one example, the application can determine relevant containers without regard to whether the user 106 has previously accessed the containers. In such examples, the weights associated with edges representing relationships between the user 106 and containers previously accessed by the user 106 may be weighted to reflect that the user 106 has previously accessed the containers. In other examples, the application can determine relevant containers that the user 106 has previously visited separately from determining relevant containers that the user 106 has not previously visited. For instance, the application can determine relevant containers that the user 106 has previously visited for a first portion of a user interface (e.g., working documents) separately from determining relevant containers that the user 106 has not previously visited for a second portion of the user interface (e.g., recommendations or suggestions). Or, in an example, the application can determine relevant containers that the user 106 has previously accessed and can subsequently determine relevant containers that the user 106 has not previously accessed. Such an example can be useful for surfacing content that is most relevant to the user 106 to the extent that such content is available and then falling back to other content that may be useful to the user 106, but that the user 106 has not accessed.

In at least one example, for each container determined to be relevant to a user 106, the application can determine which container elements associated with each container are relevant to a user 106 based at least in part on the graph (e.g., graph 200). The application can locate the object associated with the user 106 (e.g., object 202). The application can identify relationships between the user 106 and one or more container elements that are associated with same container. In at least one example, the application can identify the relationships between the user 106 and the one or more container elements via transitive closure of the graph. That is, the application can determine other objects that correspond to container elements that are reachable from the object associated with the user 106 via an edge (e.g., edge 208, edge 230, edge 232).

In at least one example, the application can leverage weights associated with the identified relationships to determine relevant container elements. In some examples, the application can determine that a container element with which the user 106 has a relationship that is associated with a weight above a threshold weight is a relevant container element. For each container, the application can select one or more container elements that correspond to a relationship with a weight above a threshold weight as relevant container elements. In at least one example, the application can rank each of the container elements in the one or more container elements based at least in part on the weight associated with the relationship with the user 106. That is, all of the container elements in the one or more container elements can be relevant to the user 106, but the container element corresponding to a relationship with a highest weight can be the most relevant to the user 106 (in the context of a particular container). In at least one example, the number of relevant container elements selected can be determined by a size and/or arrangement of a user interface and the ranking can correspond to a position on the user interface.

In other examples, the application can rank the container elements with respect to each container such that a top ranking container element can be associated with a relationship having a largest weight and a bottom ranking container element can be associated with a relationship having a smallest weight. In such examples, the application can select a top ranking container element or a group of top ranking container elements as relevant container elements for a particular container. In at least one example, the number of relevant containers selected can be determined by a size and/or arrangement of a user interface and the ranking can correspond to a position on the user interface.

In at least one example, the application can determine relevant container elements for each container without regard to whether the user 106 has previously accessed the container elements. In such examples, the weights associated with relationships between the user 106 and container elements previously accessed by the user 106 may be weighted to reflect that the user 106 has previously accessed the container elements. In other examples, the application can determine relevant container elements that the user 106 has previously visited separately from determining relevant container elements that the user 106 has not previously visited. For instance, in an example, the application can determine relevant container elements that the user 106 has previously visited and can subsequently determine relevant container elements that the user 106 has not previously visited. Such an example can be useful for surfacing content that is most relevant to the user 106 to the extent that such content is available and then falling back to other content that may be useful to the user 106, but that the user 106 has not accessed. Additionally and/or alternatively, determining relevant container elements that the user 106 has not previously visited can be useful for recommending content that may be relevant to a user 106.

As described above, in some examples, a weight associated with a relationship between a user 106 and a container or a container element can be determined based on weights associated with individual interactions between a user 106 and a same container or a same container element. Or, a relationship between a container and a container element can be determined based on weights associated with individual interactions between the container and the container element. In at least one example, the weights associated with the individual interactions can be used to determine which interaction to surface in association with an interface element corresponding to a container element in a user interface. For instance, based at least in part on determining that a container element is relevant to a user 106, the application can determine an interaction with the container element that is the most relevant interaction based at least in part on the weights associated with the individual interactions with the container element. That is, the application can select the interaction with the highest weight as the interaction to surface via the user interface. In some examples, the most relevant interaction might not be associated with the user 106.

Block 312 illustrates generating a user interface personalized for the user 106 based at least in part on the content. The application(s) 122 can be configured to generate user interface(s) for individual application(s) 122 that can be presented to user(s) 106 via device(s) 108 associated with the user(s) 106. In at least one example, an application of the application(s) 122 can be associated with a collaborative service application and the application can be configured to generate a user interface to enable user(s) 106 to interface with a collaborative computing environment. In at least one example, the application can access data associated with a number of containers determined to be the most relevant containers for a user 106. In some examples, the number can be determined based at least in part on the size and/or configuration of the user interface. Additionally, the application can access data associated with a number of container elements for each container that are determined to be relevant to the user 106. The application can generate a user interface based at least in part on the relevant container(s) and/or relevant container element(s).

As described above, in some examples, the user interface can correspond to a content page (e.g., content page 150). In an example, the user interface(s) can be configured to present interface elements representative of container(s) and/or container element(s) to a user 106 via the content page. In at least one example, the content page may be a content feed configured to present user(s) 106 with frequently updated content. The user interface(s) can provide a user 106 with content corresponding to containers and/or container elements that the user 106 is likely going to want to access at a particular moment in time, as described above.

For instance, the user interface(s) can include a group of containers that are relevant for the user 106. In some examples, containers in the group of containers can be determined to be relevant based on interactions between the user 106 and the containers. In other examples, containers in the group of containers can be determined to be relevant based on interactions between other users 106 who are related to the user 106 and the containers. As a non-limiting example, the user interface(s) can include a group of sites that are relevant for a user 106 working in a collaborative computing environment. In at least one example, the user interface(s) can include a group of container elements associated with a container that are relevant to a user 106. In some examples, container elements in the group of container elements can be determined to be relevant based on interactions between the user 106 and the container elements. In other examples, container elements in the group of container elements can be determined to be relevant based on interactions between other users 106 who are related to the user 106 and the container elements. In the non-limiting example above, a site of the group of sites that are relevant for a user 106 can be associated with a plurality of documents that are determined to be relevant to the user 106. The user interface(s) can present the site and plurality of documents in an order of relevance to the user 106 so that the user 106 can efficiently locate the site and a document that he or she is interested in working on at a given time.

Additionally and/or alternatively, the user interface(s) can provide a user 106 with recommendations and/or suggestions of content that can be determined using the data structures (e.g., graph 200) described above. In other examples, the user interface(s) can include a search results portion, as described below in FIG. 4.

Block 314 illustrates causing the user interface to be presented via a device 108 associated with the user 106. As described above, the application(s) 122 can cause the user interface(s) for individual application(s) 122 to be presented to user(s) 106 via device(s) 108 associated with the user(s) 106.

FIG. 4 is a flow diagram that illustrates an example process 400 to generate results responsive to a query associated with container(s) and/or container element(s). In at least one example, the query may be a search query to search content associated with a collaborative computing environment. As a non-limiting example, a query may be associated with a particular document that a team of users 106 is working on in the collaborative computing environment and/or a video uploaded to the collaborative computing environment. Or, a query may be associated with a particular site (e.g., team site, blogging site, publishing site, etc.) associated with a collaborative computing environment. In additional and/or alternative examples, the queries can be associated with user(s) 106.

Block 402 illustrates receiving, from a device 108 associated with a user 106, a query associated with a container or a container element. As described above, in at least one example, the application(s) 122 can receive queries from device(s) 108 associated with user(s) 106. In at least one example, an application of the application(s) 122 can be associated with a collaborative service application. The application can provide a search function for user(s) 106 to locate container(s), container element(s), other user(s) 106, etc. In some examples, the queries can be associated with container(s) and/or container element(s). In other examples, the queries can be associated with users 106.

Block 404 illustrates accessing a graph representative of interactions between the user 106, container(s), and container element(s). The application can access the database 124 to access the graph(s) 128 and/or other data structure(s). An example graph 200 is illustrated in FIG. 2.

Block 406 illustrates generating a result based at least in part on the graph. The application can access the database 124 to access the graph(s) 128. The application can locate the object corresponding to the user 106 (e.g., object 202). In at least one example, the application can identify the relationships between the user 106 and container(s) and/or container element(s) via transitive closure of the graph (e.g., graph 200). That is, the application can determine other objects that correspond to container(s) and/or container element(s) that are reachable from the object associated with the user 106 via an edge. The application can compare data associated with the query with data associated with each of the container(s) and/or container element(s) identified by the transitive closure of the graph (e.g., graph 200). Based at least in part on determining that a container and/or a container element are substantially similar to the query, the application can generate a result based at least in part on the container and/or the container element. In at least one example, a container and/or a container element are substantially similar to the query if a similarity metric comparing the container and/or the container element to the query is above a threshold value or within a range of values indicative of similarity. In some examples, more than one container and/or container element can be associated with a similarity metric that is above the threshold value or within the range of values. In such examples, a top ranking container and/or container element may be selected for the result.

Block 408 illustrates sending the result to the device 108 associated with the user 106. The application can send the result to the device 108 associated with the user 106. In at least one example, the application can integrate the result into a user interface associated with a content page, as described above. As described above, the application can cause the user interface to be presented via device(s) 108 associated with the user(s) 106.

A. A system comprising: one or more processors; and memory that stores one or more modules that are executable by the one or more processors to cause the system to perform operations comprising: accessing data associated with interactions between a plurality of users, a plurality of containers, and a plurality of container elements; determining, based at least in part on the data, a first interaction of the interactions between a user of the plurality of users and a container of the plurality of containers; determining a first relationship between the user and the container based at least in part on the first interaction; determining a first weight corresponding to the first relationship based in part on at least one of a first action or a first timestamp associated with the first interaction; generating a data structure to represent the relationship and one or more other relationships between the plurality of users, the plurality of containers, and the plurality of container elements; determining that the container is relevant to the user based at least in part on the data structure and the first weight; and generating a user interface configured to surface the content via a device associated with the user, wherein a position of a graphical element representative of the container on the user interface is determined based at least in part on the first weight.

B. A system as paragraph A recites, the operations further comprising: determining, based at least in part on the data, a second interaction of the interactions between the user and a container element of the plurality of container elements, wherein the container element is associated with the container; determining a second relationship between the user and the container element based at least in part on the second interaction; determining a second weight corresponding to the second relationship based in part on at least one of a second action or a second timestamp associated with the second interaction; determining that the container element is relevant to the user based at least in part on the second weight; and generating the user interface such that an interface element representative of the container element is associated with the graphical element on the user interface and a position of the interface element is determined based at least in part on the second weight.

C. A system as paragraph B recites, wherein the user interface corresponds to a content page associated with a collaborative computing environment.

D. A system as paragraph C recites, wherein the container corresponds to a site associated with the collaborative computing environment and the container element corresponds to a document that is accessible by a group of users of the plurality of users that are associated with the collaborative computing environment.

E. A system as any of paragraphs A-D recite, the operations further comprising providing an interface configured to access the data structure to determine that the container is relevant to the user.

F. A method comprising: accessing data associated with interactions between a user and content associated with a collaborative computing environment, the content including a plurality of containers and one or more container elements associated with each container of the plurality of containers; determining, based at least in part on the data, relationships between at least one of: the user and the plurality of containers; the user and the plurality of container elements; or individual containers of the plurality of containers and individual container elements associated with each of the individual containers; determining weights corresponding to individual relationships of the relationships; determining at least a portion of the content that is relevant to the user based at least in part on the weights; and generating a content page associated with the collaborative computing environment configured with functionality to present at least the portion of the content to the user.

G. A method as paragraph F recites, further comprising: determining that a first relationship of the individual relationships is associated with a first weight, the first relationship being associated with the user and a first container of the plurality of containers; determining that a second relationship of the individual relationships is associated with a second weight, the second relationship being associated with the user and a second container of the plurality of containers; determining that the first weight and the second weight are at least one of top ranking weights or above a threshold weight; and determining that the first container and the second container are relevant to the user.

H. A method as paragraph F or G recite, further comprising: determining that a first relationship of the individual relationships is associated with a first weight, the first relationship being associated with the user and a first container element of the one or more container elements; determining that a second relationship of the individual relationships is associated with a second weight, the second relationship being associated with the user and a second container element of the one or more container elements; determining that the first weight and the second weight are at least one of top ranking weights or above a threshold weight; and determining that the first container element and the second container element are relevant to the user.

I. A method as paragraph H recites wherein the first container element and the second container element are associated with a same container of the plurality of containers.

J. A method as any of paragraphs F-I recite, further comprising: determining that a first relationship of the individual relationships is associated with a first weight, the first relationship being associated with a container of the plurality of containers and a first container element associated with the container; determining that a second relationship of the individual relationships is associated with a second weight, the second relationship being associated with the container and a second container element associated with the container; determining that the first weight and the second weight are at least one of top ranking weights or above a threshold weight; and determining that the first container element and the second container element are relevant to the container.

K. A method as any of paragraphs F-J recite, further comprising: determining that a first relationship of the individual relationships is associated with a first weight, the first relationship being associated with the user and a first container of the plurality of containers; determining that a second relationship of the individual relationships is associated with a second weight, the second relationship being associated with the user and a second container of the plurality of containers; determining that the first weight is at least one of a top ranking weight or above a threshold weight; determining that the second weight is not the top ranking weight or above the threshold weight; determining that the first container is relevant to the user; and determining that the second container is not relevant to the user.

L. One or more computer-readable media encoded with instructions that, when executed by a processor, configure a computer to perform a method as any of paragraphs F-K recite.

M. A device comprising one or more processors and one or more computer readable media encoded with instructions that, when executed by the one or more processors, configure a computer to perform a computer-implemented method as any of paragraphs F-K recite.

N. A method comprising: means for accessing data associated with interactions between a user and content associated with a collaborative computing environment, the content including a plurality of containers and one or more container elements associated with each container of the plurality of containers; means for determining, based at least in part on the data, relationships between at least one of: the user and the plurality of containers; the user and the plurality of container elements; or individual containers of the plurality of containers and individual container elements associated with each of the individual containers; means for determining weights corresponding to individual relationships of the relationships; means for determining at least a portion of the content that is relevant to the user based at least in part on the weights; and means for generating a content page associated with the collaborative computing environment configured with functionality to present at least the portion of the content to the user.

O. A method as paragraph N recites, further comprising: means for determining that a first relationship of the individual relationships is associated with a first weight, the first relationship being associated with the user and a first container of the plurality of containers; means for determining that a second relationship of the individual relationships is associated with a second weight, the second relationship being associated with the user and a second container of the plurality of containers; means for determining that the first weight and the second weight are at least one of top ranking weights or above a threshold weight; and means for determining that the first container and the second container are relevant to the user.

P. A method as paragraph N or O recite, further comprising: means for determining that a first relationship of the individual relationships is associated with a first weight, the first relationship being associated with the user and a first container element of the one or more container elements; means for determining that a second relationship of the individual relationships is associated with a second weight, the second relationship being associated with the user and a second container element of the one or more container elements; determining that the first weight and the second weight are at least one of top ranking weights or above a threshold weight; and means for determining that the first container element and the second container element are relevant to the user.

Q. A method as paragraph O recites wherein the first container element and the second container element are associated with a same container of the plurality of containers.

R. A method as any of paragraphs N-Q recite, further comprising: means for determining that a first relationship of the individual relationships is associated with a first weight, the first relationship being associated with a container of the plurality of containers and a first container element associated with the container; means for determining that a second relationship of the individual relationships is associated with a second weight, the second relationship being associated with the container and a second container element associated with the container; means for determining that the first weight and the second weight are at least one of top ranking weights or above a threshold weight; and determining that the first container element and the second container element are relevant to the container.

S. A method as any of paragraphs N-R recite, further comprising: means for determining that a first relationship of the individual relationships is associated with a first weight, the first relationship being associated with the user and a first container of the plurality of containers; means for determining that a second relationship of the individual relationships is associated with a second weight, the second relationship being associated with the user and a second container of the plurality of containers; means for determining that the first weight is at least one of a top ranking weight or above a threshold weight; means for determining that the second weight is not the top ranking weight or above the threshold weight; means for determining that the first container is relevant to the user; and means for determining that the second container is not relevant to the user.

T. A system comprising: one or more processors; and memory that stores one or more modules that are executable by the one or more processors to cause the system to perform operations comprising: accessing data associated with interactions between a plurality of users, a plurality of containers, and a plurality of container elements, wherein a container of the plurality of containers is associated with one or more container elements of the plurality of container elements; determining, based at least in part on the data, relationships between a user of the plurality of users and at least one of the container or a container element of the one or more container elements; generating a data structure to represent the relationships, the data structure comprising a graph including: a plurality of objects including a first object that corresponds to the user, a second object that corresponds to the container, and a third object that corresponds to the container element; and one or more edges connecting pairs of objects of the plurality of objects; accessing the data structure to determine content that is relevant to the user; generating a user interface configured with functionality to present at least a portion of the content to the user; and causing the user interface to be presented via a device associated with the user.

U. A system as paragraph T recites, the operations further comprising: determining a relationship between the user and the container element based at least in part on determining that the user interacted with the container element by at least one of uploading the container element, modifying the container element, tagging the container element, sharing the container element, or viewing the container element; and determining an edge of the one or more edges that represents the relationship between the user and the container element, the edge connecting the first object and the third object.

V. A system as paragraphs T or U recite, the operations further comprising: determining a first relationship between the user and the container based at least in part on determining that the user interacted with the container by at least one of creating the container, modifying a container element associated with the container, tagging the container, sharing the container, or viewing at least one of the container element associated with the container, the container, or a home page associated with the container; and determining a first edge of the one or more edges that represents the first relationship between the user and the container, the first edge connecting the first object and the second object.

W. A system as paragraph V recites, the operations further comprising: determining a second relationship between the container and the container element based at least in part on determining that users of the plurality of users interacted with the container element by at least one of uploading the container element, modifying the container element, tagging the container element, sharing the container element, or viewing the container element; and determining a second edge of the one or more edges that represents the second relationship between the container and the container element, the second edge connecting the second object and the third object.

X. A system as paragraph W recites, the operations further comprising: determining a third relationship between the user and the container element based at least in part on the first edge and the second edge; and determining a third edge of the one or more edges that represents the third relationship between the user and the container element, the third edge connecting the first object and the third object.

Y. A system as any of paragraphs T-X recite, the operations further comprising: determining, based at least in part on the data, that the user has not previously interacted with the container; determining a relationship between the user and the container based at least in part on one or more interactions between users of the plurality of users and the container, wherein the users are associated with the user; and determining an edge of the one or more edges that represents the relationship between the user and the container, the edge connecting the first object and the second object.

Z. A system as any of paragraphs T-Y recite, the operations further comprising: determining, based at least in part on the data, that the user has not previously interacted with the container element; determining a relationship between the user and the container element based at least in part on one or more interactions between users of the plurality of users and the container element, wherein the users are associated with the user; and determining an edge of the one or more edges that represents the relationship between the user and the container element, the edge connecting the first object and the third object.

AA. A system as any of paragraphs T-Z recite, the operations further comprising: determining a relationship of the relationships based at least in part on an interaction of the interactions, wherein the relationship is between the user and the container; determining an action and a timestamp associated with the interaction; determining an edge of the one or more edges that represents the relationship in the graph; and determining a first weight associated with the edge based at least in part on at least one of the action or the timestamp.

AB. A system as paragraph AA recites, the operations further comprising: determining that the container is relevant to the user based at least in part on determining that the first weight associated with the edge is at least one of above a threshold weight or greater than a second weight associated with a non-relevant container; and prioritizing the container on the user interface based at least in part on the first weight.

### CONCLUSION

Although the subject matter has been described in language specific to structural features and/or methodological acts, it is to be understood that the subject matter defined in the appended claims is not necessarily limited to the specific features or acts described. Rather, the specific features and acts are described as illustrative forms of implementing the claims.

Conditional language such as, among others, “can,” “could,” “might” or “can,” unless specifically stated otherwise, are understood within the context to present that certain examples include, while other examples do not necessarily include, certain features, elements and/or steps. Thus, such conditional language is not generally intended to imply that certain features, elements and/or steps are in any way required for one or more examples or that one or more examples necessarily include logic for deciding, with or without input or prompting, whether certain features, elements and/or steps are included or are to be performed in any particular example. Conjunctive language such as the phrase “at least one of X, Y or Z,” unless specifically stated otherwise, is to be understood to present that an item, term, etc. can be either X, Y, or Z, or a combination thereof.

What is claimed is:

1. A system comprising:
one or more processors; and
memory that stores one or more modules that are executable by the one or more processors to cause the system to perform operations comprising:
accessing data associated with interactions between a plurality of users, a plurality of containers, and a plurality of container elements;
determining, based at least in part on the data, a first interaction of the interactions between a user of the plurality of users and a container of the plurality of containers;
determining a first relationship between the user and the container based at least in part on the first interaction;
determining a first weight corresponding to the first relationship based in part on at least one of a first action or a first timestamp associated with the first interaction;
generating a data structure to represent the relationship and one or more other relationships between the plurality of users, the plurality of containers, and the plurality of container elements;
determining that the container is relevant to the user based at least in part on the data structure and the first weight; and
generating a user interface configured to surface the content via a device associated with the user, wherein a position of a graphical element representative of the container on the user interface is determined based at least in part on the first weight.

2. A system as claim 1 recites, the operations further comprising:
determining, based at least in part on the data, a second interaction of the interactions between the user and a container element of the plurality of container elements, wherein the container element is associated with the container;
determining a second relationship between the user and the container element based at least in part on the second interaction;
determining a second weight corresponding to the second relationship based in part on at least one of a second action or a second timestamp associated with the second interaction;
determining that the container element is relevant to the user based at least in part on the second weight; and
generating the user interface such that an interface element representative of the container element is associated with the graphical element on the user interface and a position of the interface element is determined based at least in part on the second weight.

3. A system as claim 2 recites, wherein the user interface corresponds to a content page associated with a collaborative computing environment.

4. A system as claim 3 recites, wherein the container corresponds to a site associated with the collaborative computing environment and the container element corresponds to a document that is accessible by a group of users of the plurality of users that are associated with the collaborative computing environment.

5. A system as claim 1 recites, the operations further comprising providing an interface configured to access the data structure to determine that the container is relevant to the user.

6. A method comprising:
accessing data associated with interactions between a user and content associated with a collaborative computing environment, the content including a plurality of containers and one or more container elements associated with each container of the plurality of containers;
determining, based at least in part on the data, relationships between at least one of:
the user and the plurality of containers;
the user and the plurality of container elements; or
individual containers of the plurality of containers and individual container elements associated with each of the individual containers;
determining weights corresponding to individual relationships of the relationships;
determining at least a portion of the content that is relevant to the user based at least in part on the weights; and
generating a content page associated with the collaborative computing environment configured with functionality to present at least the portion of the content to the user.

7. A method as claim 6 recites, further comprising:
determining that a first relationship of the individual relationships is associated with a first weight, the first relationship being associated with the user and a first container of the plurality of containers;
determining that a second relationship of the individual relationships is associated with a second weight, the second relationship being associated with the user and a second container of the plurality of containers;
determining that the first weight and the second weight are at least one of top ranking weights or above a threshold weight; and
determining that the first container and the second container are relevant to the user.

8. A method as claim 6 recites, further comprising:
determining that a first relationship of the individual relationships is associated with a first weight, the first relationship being associated with the user and a first container element of the one or more container elements;
determining that a second relationship of the individual relationships is associated with a second weight, the second relationship being associated with the user and a second container element of the one or more container elements;
determining that the first weight and the second weight are at least one of top ranking weights or above a threshold weight; and
determining that the first container element and the second container element are relevant to the user.

9. A method as claim 8 recites wherein the first container element and the second container element are associated with a same container of the plurality of containers.

10. A method as claim 6 recites, further comprising:
determining that a first relationship of the individual relationships is associated with a first weight, the first relationship being associated with a container of the plurality of containers and a first container element associated with the container;
determining that a second relationship of the individual relationships is associated with a second weight, the second relationship being associated with the container and a second container element associated with the container;
determining that the first weight and the second weight are at least one of top ranking weights or above a threshold weight; and
determining that the first container element and the second container element are relevant to the container.

11. A method as claim 6 recites, further comprising:
determining that a first relationship of the individual relationships is associated with a first weight, the first relationship being associated with the user and a first container of the plurality of containers;
determining that a second relationship of the individual relationships is associated with a second weight, the second relationship being associated with the user and a second container of the plurality of containers;
determining that the first weight is at least one of a top ranking weight or above a threshold weight;
determining that the second weight is not the top ranking weight or above the threshold weight;
determining that the first container is relevant to the user; and
determining that the second container is not relevant to the user.

12. A system comprising:
one or more processors; and
memory that stores one or more modules that are executable by the one or more processors to cause the system to perform operations comprising:
accessing data associated with interactions between a plurality of users, a plurality of containers, and a plurality of container elements, wherein a container of the plurality of containers is associated with one or more container elements of the plurality of container elements;
determining, based at least in part on the data, relationships between a user of the plurality of users and at least one of the container or a container element of the one or more container elements;
generating a data structure to represent the relationships, the data structure comprising a graph including:
a plurality of objects including a first object that corresponds to the user, a second object that corresponds to the container, and a third object that corresponds to the container element; and
one or more edges connecting pairs of objects of the plurality of objects;
accessing the data structure to determine content that is relevant to the user;
generating a user interface configured with functionality to present at least a portion of the content to the user; and
causing the user interface to be presented via a device associated with the user.

13. A system as claim 12 recites, the operations further comprising:
determining a relationship between the user and the container element based at least in part on determining that the user interacted with the container element by at least one of uploading the container element, modifying the container element, tagging the container element, sharing the container element, or viewing the container element; and
determining an edge of the one or more edges that represents the relationship between the user and the container element, the edge connecting the first object and the third object.

14. A system as claim 12 recites, the operations further comprising:
determining a first relationship between the user and the container based at least in part on determining that the user interacted with the container by at least one of creating the container, modifying a container element associated with the container, tagging the container, sharing the container, or viewing at least one of the container element associated with the container, the container, or a home page associated with the container; and
determining a first edge of the one or more edges that represents the first relationship between the user and the container, the first edge connecting the first object and the second object.

15. A system as claim 14 recites, the operations further comprising:
determining a second relationship between the container and the container element based at least in part on determining that users of the plurality of users interacted with the container element by at least one of uploading the container element, modifying the container element, tagging the container element, sharing the container element, or viewing the container element; and
determining a second edge of the one or more edges that represents the second relationship between the container and the container element, the second edge connecting the second object and the third object.

16. A system as claim 15 recites, the operations further comprising:
determining a third relationship between the user and the container element based at least in part on the first edge and the second edge; and
determining a third edge of the one or more edges that represents the third relationship between the user and the container element, the third edge connecting the first object and the third object.

17. A system as claim 12 recites, the operations further comprising:
determining, based at least in part on the data, that the user has not previously interacted with the container;
determining a relationship between the user and the container based at least in part on one or more interactions between users of the plurality of users and the container, wherein the users are associated with the user; and
determining an edge of the one or more edges that represents the relationship between the user and the container, the edge connecting the first object and the second object.

18. A system as claim 12 recites, the operations further comprising:
determining, based at least in part on the data, that the user has not previously interacted with the container element;
determining a relationship between the user and the container element based at least in part on one or more interactions between users of the plurality of users and the container element, wherein the users are associated with the user; and
determining an edge of the one or more edges that represents the relationship between the user and the container element, the edge connecting the first object and the third object.

19. A system as claim 12 recites, the operations further comprising:
determining a relationship of the relationships based at least in part on an interaction of the interactions, wherein the relationship is between the user and the container;
determining an action and a timestamp associated with the interaction;
determining an edge of the one or more edges that represents the relationship in the graph; and
determining a first weight associated with the edge based at least in part on at least one of the action or the timestamp.

20. A system as claim 19 recites, the operations further comprising:
determining that the container is relevant to the user based at least in part on determining that the first weight associated with the edge is at least one of above a threshold weight or greater than a second weight associated with a non-relevant container; and
prioritizing the container on the user interface based at least in part on the first weight.
